(19) United States
(12) Patent Application Publication
(10) Pub. No.: US 2026/0181406 A1
(43) Pub. Date: Jun. 25, 2026

(54) MANAGEMENT AND DISTRIBUTION OF ARTIFICIAL INTELLIGENCE MODELS

(71) Applicant: Sony Group Corporation, Tokyo (JP)

(72) Inventors: Chen SUN, Beijing (CN); Tao CUI, Beijing (CN)

(73) Assignee: Sony Group Corporation, Tokyo (JP)

(21) Appl. No.: 18/725,151

(22) PCT Filed: Jan. 4, 2023
(86) PCT No.: PCT/CN2023/070258

§ 371 Date: Jun. 28, 2024

(30) Foreign Application Priority Data
Jan. 7, 2022 (CN) 202210015281.2

(51) Int. Cl. H04W 16/28; H04W 24/10

(52) U.S. Cl. CPC H04W 16/28; H04W 24/10

(57) ABSTRACT

The present disclosure relates to management and distribution of an artificial intelligence models. There is provided a method performed by a network device, comprising: determining an artificial intelligence model for a user equipment, i.e. UE, from a plurality of artificial intelligence models for beam prediction based on a beam measurement result reported by the UE; and sending, to the UE, indication information associated with the determined artificial intelligence model.

### TECHNICAL FIELD

The present disclosure generally relates to beam management and, more particularly, to management and distribution of artificial intelligence models for beam prediction.

### BACKGROUND

For a high-frequency radio signal, for example, a millimeter-band radio signal, large path-loss will occur during spatial propagation, which will greatly affect a high-frequency radio communication system, such as a 5G communication system. In the high-frequency radio communication system, a directional beam is formed using beamforming technology, and in general, the narrower the beam, the larger the signal gain.

However, once a direction of the beam deviates from a user, the user cannot receive the signal.

Therefore, for high-frequency radio communication, beam management technology may be employed. A goal of beam management is to establish and maintain a suitable beam pair. A suitable receiving beam is selected at a receiver and a suitable transmitting beam is selected at a transmitter, and they jointly maintain a good radio connectivity.

Generally, the beam management includes initial beam establishment, beam adjustment, and beam recovery. The beam adjustment is mainly used for adapting to movement and/or rotation of a terminal and a slow change in an environment.

The beam adjustment may include downlink beam adjustment and uplink beam adjustment. The downlink beam adjustment includes downlink transmitting-side beam adjustment and downlink receiving-side beam adjustment. The downlink beam adjustment and the uplink beam adjustment have the same purpose, both for maintaining a suitable beam pair, accordingly, if a suitable downlink beam pair is obtained, the downlink beams can be directly used for uplink.

A main purpose of the downlink transmitting-side beam adjustment is to optimize a network transmitting beam under the condition that a terminal receiving beam is not changed. To achieve this, the terminal may measure a set of reference signals, which correspond to a set of downlink beams. FIG. 1A is a schematic diagram illustrating exemplary downlink transmitting-side beam adjustment according to the related art. As shown in FIG. 1A, a network sequentially transmits different downlink beams RS-1 to RS-6, i.e., performs beam scanning, and the terminal receiving beam remains unchanged during the measurement, so that the measurement result reflects qualities of different transmitting beams for the receiving beam. The terminal may perform measurement report for 4 reference signals, that is, a report may be made for at most 4 beams in one reporting instance. Each such a report may include:
(1) indicating the reference signal or beam (up to 4) targeted by the report;
(2) L1-RSRP (Layer 1-Reference Signal Receiving Power) of a strongest beam; and
(3) for the remaining beams (up to 3), reporting a difference between L1-RSRPs of the remaining beams and the strongest beam.

The network can decide whether to adjust a current beam according to the measurement result reported by the terminal.

A main purpose of the downlink receiving-side beam adjustment is to find an optimal terminal receiving beam under the condition that the network transmitting beam is not changed. To achieve this, the terminal must be configured with a set of downlink reference signals (RSs), which are all emitted from a same beam of the network, the beam being the current serving beam. FIG. 1B is a schematic diagram illustrating an exemplary downlink receiving-side beam adjustment according to the related art. As shown in FIG. 1B, the terminal performs receiving-side beam scanning to sequentially measure a set of reference signals (RSs) configured. Through the measurement, the terminal can adjust its own current receiving beam.

Since the downlink receiving-side beam adjustment is made inside the terminal, there is generally no report for the receiving-side beam adjustment.

The measurement for beam management may be based on an SSB (Synchronization Signal and PBCH block) or a CSI-RS (Channel State Information-Reference Signal).

### SUMMARY

A brief summary of the present disclosure is presented herein to provide a basic understanding of some aspects of the present disclosure. However, it should be understood that this summary is not an exhaustive overview of the present disclosure. It is not intended to determine key or critical elements of the present disclosure or to limit the scope of the present disclosure. Its purpose is only to present certain concepts of the present disclosure in a simplified form as a prelude to the more detailed description to be presented later.

According to an aspect of the present disclosure, there is provided a method performed by a network device, comprising: determining an artificial intelligence model for a user equipment (UE) from a plurality of artificial intelligence models for beam prediction based on a beam measurement result reported by the UE; and sending, to the UE, indication information associated with the determined artificial intelligence model.

According to some embodiments, the beam measurement result reported by the UE may comprise a beam intensity-based base station beam ranking sequence.

According to some embodiments, the method may further comprise: receiving, from the UE, information associated with a beam prediction period of the UE; and determining the artificial intelligence model for beam prediction for the UE based on both the beam measurement result and the information associated with the beam prediction period of the UE.

According to some embodiments, the method may further comprise sending, to the UE, the indication information associated with the determined artificial intelligence model via at least one of: radio resource control (RRC) signaling, or high-layer signaling, or downlink control information (DCI) indication.

According to some embodiments, the method may further comprise receiving, from the UE, a request for the artificial intelligence model for beam prediction.

According to some embodiments, the method may further comprise receiving, from the UE, capability information, which indicates information of support of the UE for the artificial intelligence model for beam prediction.

According to some embodiments, each artificial intelligence model may be defined by one model parameter set, the method further comprising maintaining a data table. The data table comprises at least: a beam intensity-based base station beam ranking sequence and a corresponding artificial intelligence model parameter set; or, the beam intensity-based base station beam ranking sequence, a beam prediction period, and the corresponding artificial intelligence model parameter set.

According to some embodiments, the method may further comprise: receiving a plurality of local training results from a plurality of UEs, wherein the local training result of each UE is obtained by the UE training a corresponding artificial intelligence model by using a local measurement result, and the local measurement result of each UE comprises at least reference signal measurement times and a receiving beam selection results corresponding to the reference signal measurement times; classifying the plurality of local training results from the plurality of UEs to obtain a plurality of sets of local training results based on at least one of: the beam intensity-based base station beam ranking sequences, or the beam intensity-based base station beam ranking sequences and the beam prediction periods; merging each set of local training results in the plurality of sets of local training results to obtain a plurality of merging results; and updating the artificial intelligence model parameter set in the data table using the plurality of merging results.

According to some embodiments, the method may further comprise: receiving a plurality of local measurement results from a plurality of UEs, wherein the local measurement result of each UE comprises at least reference signal measurement times and receiving beam selection results corresponding to the reference signal measurement times; classifying data of the plurality of local measurement results from the plurality of UEs to obtain at least one set of training data based on at least one of: the beam intensity-based base station beam ranking sequences, or the beam intensity-based base station beam ranking sequences and the beam prediction periods; training a corresponding artificial intelligence model in the plurality of artificial intelligence models using the at least one set of training data to obtain at least one training result; and updating the artificial intelligence model parameter sets in the data table using the at least one training result.

According to another aspect of the present disclosure, there is provided a network device, comprising: a memory storing computer-executable instructions; and a processor coupled with the memory and configured to execute the computer-executable instructions to perform the operations of the method as described above.

According to another aspect of the present disclosure, there is provided a method performed by a user equipment (UE), comprising: reporting, to a network device, a beam measurement result; and receiving, from the network device, indication information associated with an artificial intelligence model for beam prediction for the UE, wherein the artificial intelligence model for beam prediction for the UE is determined by the network device from a plurality of artificial intelligence models for beam prediction based on the beam measurement result.

According to some embodiments, the beam measurement result may comprise a beam intensity-based base station beam ranking sequence.

According to some embodiments, the method may further comprise: sending, to the network device, information associated with a beam prediction period. The artificial intelligence model for beam prediction for the UE is determined by the network device based on both the beam measurement result and the information associated with the beam prediction period. The method may further comprise: performing beam prediction using the artificial intelligence model indicated by the indication information.

According to some embodiments, the indication information associated with the artificial intelligence model for beam prediction for the UE indicates a plurality of alternative artificial intelligence models, the method further comprising: determining a beam prediction period; selecting an artificial intelligence model corresponding to the determined beam prediction period from the plurality of alternative artificial intelligence models; and performing beam prediction using the selected artificial intelligence model.

According to some embodiments, the indication information is transmitted via at least one of: RRC signaling; or high-layer signaling; or DCI indication.

According to some embodiments, the method may further comprise sending, to the network device, a request for the artificial intelligence model for beam prediction.

According to some embodiments, the method may further comprise sending, to the network device, capability information. The capability information indicates information of support of the UE for the artificial intelligence model for beam prediction.

According to some embodiments, the method may further comprise: training the artificial intelligence model indicated by the indication information using a local measurement result to obtain a local training result, wherein the local measurement result comprises at least reference signal measurement times and receiving beam selection results corresponding to the reference signal measurement times; and sending the local training result to the network device.

According to some embodiments, the method may further comprise: sending, to the network device, a local measurement result, which comprises at least measurement times and receiving beam selection results corresponding to the measurement times.

According to another aspect of the present disclosure, the method may further comprise: a memory storing computer-executable instructions; and a processor coupled with the memory and configured to execute the computer-executable instructions to perform the operations of the methods described above.

According to another aspect of the present disclosure, there is provided a computer program medium having thereon stored computer-executable instructions which, when executed by a processor, cause the method as described above to be performed.

According to another aspect of the present disclosure, there is provided a computer program product comprising computer-executable instructions which, when executed by a processor, cause the method as described above to be performed.

### BRIEF DESCRIPTION OF THE DRAWINGS

The present disclosure may be better understood by referring to the detailed description presented below in conjunction with the accompanying drawings, wherein identical or similar reference numerals are used in all the drawings to denote identical or similar elements. The accompanying drawings, together with the detailed explanation below, are incorporated in and form a part of this specification, serving to further illustrate the embodiments of the present disclosure and explain the principles and advantages of the present disclosure. In the drawings:

FIG. 1A is a schematic diagram illustrating exemplary downlink transmitting-side beam adjustment according to the related art.

FIG. 1B is a schematic diagram illustrating exemplary downlink receiving-side beam adjustment according to the related art.

FIG. 2A is a flow diagram illustrating an exemplary method performed by a network device according to an embodiment of the present disclosure.

FIG. 2B is a flow diagram illustrating another exemplary method performed by a network device according to an embodiment of the present disclosure.

FIG. 3A is a flow diagram illustrating an exemplary method performed by a UE according to an embodiment of the present disclosure.

FIG. 3B is a flow diagram illustrating another exemplary method performed by a UE according to an embodiment of the present disclosure.

FIG. 3C is a flow diagram illustrating yet another exemplary method performed by a UE according to an embodiment of the present disclosure.

FIG. 4 is a flow diagram illustrating an exemplary communication process between a base station and a UE according to an embodiment of the present disclosure.

FIG. 5A is a schematic diagram illustrating a UE periodically measuring a reference signal sent by a base station.

FIGS. 5B, 5C, and 5D are schematic diagrams illustrating exemplary beam prediction according to an embodiment of the present disclosure.

FIG. 6 is a flow diagram illustrating an exemplary communication process between a base station and a UE according to an embodiment of the present disclosure.

FIG. 7A is a schematic diagram illustrating a structure of an LSTM according to an embodiment of the present disclosure.

FIG. 7B is a schematic diagram illustrating an internal structure of an LSTM cell.

FIG. 8A is a flow diagram illustrating an exemplary method performed by a network device according to an embodiment of the present disclosure.

FIG. 8B is a flow diagram illustrating an exemplary method performed by a UE according to an embodiment of the present disclosure.

FIG. 9 is a flow diagram illustrating an exemplary communication process performed by a base station and one of a plurality of UEs according to an embodiment of the present disclosure.

FIG. 10 is a flow diagram illustrating an exemplary method performed by a base station according to an embodiment of the present disclosure.

FIG. 11 is a flow diagram illustrating an exemplary communication process performed by a base station and one of a plurality of UEs according to an embodiment of the present disclosure.

FIG. 12 is a block diagram illustrating a first example of a schematic configuration of a base station to which the technique of the present disclosure can be applied.

FIG. 13 is a block diagram illustrating a second example of a schematic configuration of a base station to which the technique of the present disclosure can be applied.

FIG. 14 is a block diagram illustrating an example of a schematic configuration of a smartphone to which the technique of the present disclosure can be applied.

FIG. 15 is a block diagram illustrating an example of a schematic configuration of a car navigation device to which the technique of the present disclosure can be applied.

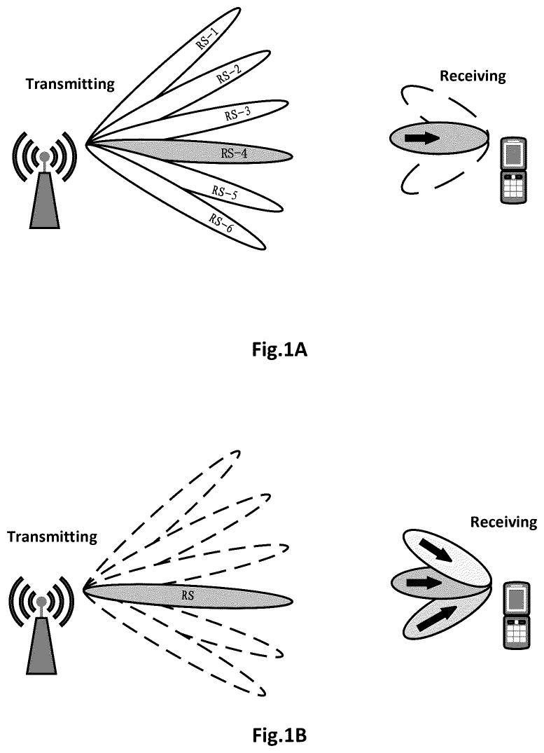

Features and aspects of the present disclosure will be clearly understood by reading the following detailed description with reference to the accompanying drawings.

### DETAILED DESCRIPTION

Various exemplary embodiments of the present disclosure will be described in detail hereinafter with reference to the accompanying drawings. For clarity and conciseness, not all implementations of the embodiments have been described in this specification. It should be noted, however, that when the embodiments of the present disclosure are implemented, many implementation-specific settings may be made according to specific requirements, so as to achieve specific goals of developers. Moreover, it should be understood that although development work may be complex and laborious, such development disclosure is only a routine task for those skilled in the art benefiting from this disclosure.

Furthermore, it should be noted that in order to avoid obscuring the present disclosure due to unnecessary details, only processing steps and/or device structures germane to the technical solutions of the present disclosure are shown in the drawings. The following description of the exemplary embodiments is merely illustrative and is not intended to be any limitation on this disclosure or its application.

The present disclosure contemplates that, a beam measurement result (e.g., reported beam intensity-based base station beam measurement information) reported by a UE is associated with a specific radio propagation environment where the UE is located. For a same base station, radio propagation environments where different UEs communicating with the base station are located are different, and therefore, reported beam measurement results are also different. Beam intensity-based base station beam measurement information may include a beam intensity-based base station beam ranking sequence or information for determining the beam intensity-based base station beam ranking sequence.

The specific “radio propagation environment” where the UE is located, herein, may be defined by a specific radio propagation characteristic set, which represents a set of various radio propagation conditions within the radio propagation environment. That, the “radio propagation environment” may be a radio propagation characteristic set formed by a radio propagation path, an emitter, etc., from the perspective of the UE.

The present disclosure contemplates that, each beam intensity-based base station beam ranking sequence is associated with a specific radio propagation characteristic set. When measurement results reported by a plurality of UEs indicate a same beam intensity-based base station beam ranking sequence, it may be considered that the plurality of UEs are in a same radio propagation environment and thus associated with a same radio propagation characteristic set. When measurement results reported by a plurality of UEs indicate different beam intensity-based base station beam ranking sequences, it may be considered that the plurality of UEs are in different radio propagation environments and thus associated with different radio propagation characteristic sets.

The present disclosure contemplates that, for different radio propagation environments where the UEs are located, different artificial intelligence models may be used for receiving beam prediction of the UEs. This can provide accurate artificial intelligence model distribution.

The present disclosure also contemplates that, for high frequency communication, when a user moves in a small range, the radio propagation environment where the UE is located does not change frequently (i.e., the beam intensity-based base station beam ranking sequence measured by the UE does not change frequently), but the UE might continuously move and/or rotate with the movement of the user, such that the UE needs to adjust a receiving beam frequently. In order to maintain good communication quality, the UE might need to perform a downlink receiving-side beam adjustment process at a higher frequency, which will accelerate power consumption of the UE. The present disclosure also contemplates that, for a different radio propagation environment where the UE is located and/or a different motion characteristic thereof (e.g., a different motion velocity, resulting in a different beam measurement period), a different artificial intelligence model may be used for beam prediction. This may provide more accurate artificial intelligence model distribution.

That is, the present disclosure contemplates that, for a different radio propagation environment, a different artificial intelligence model is selected for the beam prediction of the UE. The present disclosure also contemplates that, for both a different radio propagation environment and a different beam prediction period, a different artificial intelligence model is selected for the beam prediction of the UE.

The accurate artificial intelligence model distribution for UE enables each UE to use the artificial intelligence model which is more suitable for the radio propagation environment where the UE is located and the motion characteristic of the UE itself, so that more accurate beam prediction can be achieved, and stable communication quality is achieved while power consumption of the UE is lowered.

The present disclosure also contemplates that, at the network, a data table containing a correspondence between the beam intensity-based base station beam ranking sequence, the beam prediction period, and the artificial intelligence model (e.g., a model parameter set) is maintained. By using local measurement results (e.g. selection/replacement information of local receiving beams) of the plurality of UEs, different artificial intelligence models corresponding to different radio propagation environments and/or different beam prediction periods can be trained, and parameter sets of artificial intelligence models corresponding to different radio propagation environments and/or different beam prediction periods can be obtained and updated. This also assists in more accurate artificial intelligence model distribution.

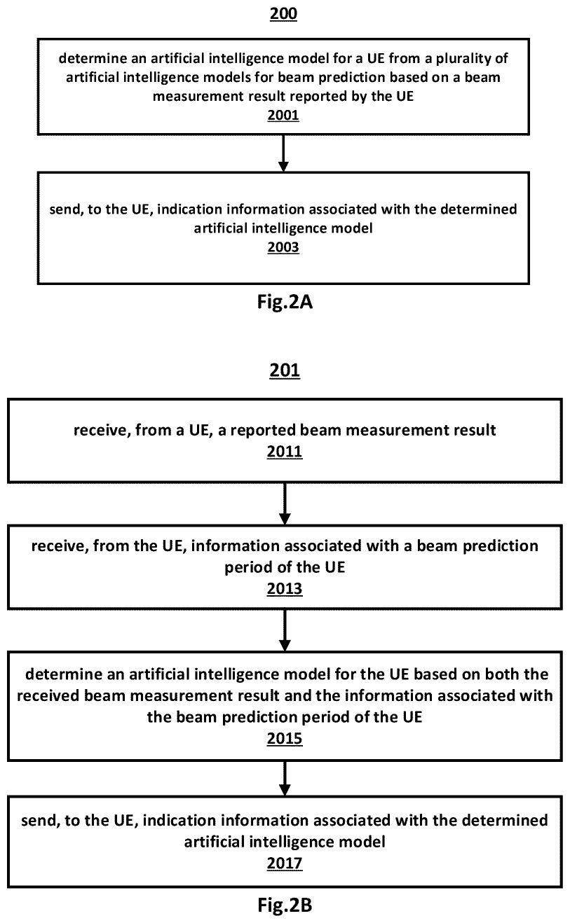

FIG. 2A is a flow diagram illustrating an exemplary method 200 performed by a network device according to an embodiment of the present disclosure. The network device may be, for example, a base station. The network device may also be a base station controller, a radio network controller, etc.

As shown in FIG. 2A, the method 200 includes a step 2001, in which an artificial intelligence model for a UE is determined from a plurality of artificial intelligence models for beam prediction based on a beam measurement result reported by the UE.

The beam measurement result may include beam intensity-based base station beam measurement information. The beam intensity-based base station beam measurement information may include a beam intensity-based base station beam ranking sequence and may further include information for determining the beam intensity-based base station beam ranking sequence.

In some embodiments, the beam measurement result may include a beam intensity-based base station beam ranking sequence. In still other embodiments, the beam measurement result may include information for determining the beam intensity-based base station beam ranking sequence, such as indexes of a strongest beam and several secondary strong beams and L1-RSRP of the strongest beam, as well as a difference between L1-RSRPs of each secondary strong beam and the strongest beam.

Each artificial intelligence model may be defined by one model parameter set. The model parameter set may contain a set of specific parameter values for characterizing the model. The model parameter set may also indicate a type of the model.

Herein, for ease of explanation, by taking an example that all artificial intelligence models are based on long short term memory network (LSTM), a different artificial intelligence model has one different model parameter set. Specifically, each different LSTM model may be defined by one different set of model parameter values, which include, for example, weights of input, forget, output, update states, and bias values of the input, forget, output, and update states. This will be described in more detail hereinafter.

Each artificial intelligence model may be associated with a beam intensity-based base station beam ranking sequence (which represents a corresponding radio propagation environment or radio propagation characteristic set). In some embodiments, each artificial intelligence model may also be associated with both a beam intensity-based base station beam ranking sequence and a beam prediction period.

At the network device, a data table may be maintained, which at least contains a correspondence between the beam measurement result and the artificial intelligence model.

In some embodiments, the data table may contain beam measurement results (e.g., the beam intensity ranking sequence) and corresponding artificial intelligence model parameter sets. In other embodiments, the data table may also contain beam measurement results, beam prediction periods, and corresponding artificial intelligence model parameter sets. Accordingly, the base station may search the data table for one or more corresponding artificial intelligence models based on (1) the beam measurement result reported by the UE or (2) both the beam measurement result reported by the UE and the beam prediction period.

In some embodiments, a plurality of artificial intelligence models for beam prediction available to the UE may be found based on the beam measurement result reported by the UE, and these plurality of alternative artificial intelligence models respectively correspond to different beam prediction periods but correspond to the same beam measurement result (e.g., the same base station beam ranking sequence).

In other embodiments, one artificial intelligence model may be found in the data table based on both the beam measurement result reported by the UE and the beam prediction period, and the model may be used for beam prediction for the UE.

Table 1 below shows a portion of an exemplary data table maintained by a base station. Assume that the base station has 4 transmitting beams 1-4, and the beam measurement result reported by the UE contains a base station beam ranking sequence of the 4 beams according to descending beam intensities. Assume that all types of artificial intelligence models are LSTM, and a different artificial intelligence model is defined by one different model parameter set. The base station may maintain the data table as shown in Table 1 below. A first column in the table 1 has therein listed all possible base station beam ranking sequences, and a second column has therein listed model parameter sets corresponding to the base station beam ranking sequences.

TABLE 1

| Base station beam | Artificial intelligence |
|---|---|
| ranking sequence | model parameter set |
| 1234 | model parameter set S1 |
| 1243 | model parameter set S2 |
| 1432 | model parameter set S3 |
| 3412 | model parameter set S4 |
| 3124 | model parameter set S5 |
| 3214 | model parameter set S6 |
| . . . | . . . |

As shown in Table 1, a different base station beam ranking sequence corresponds to a different model parameter set.

Table 2-1 below shows a portion of another exemplary data table maintained by the base station. Table 2-1 differs from Table 1 in that it also takes into account different beam prediction periods. A first column in Table 2-1 has therein listed all possible base station beam ranking sequences, a second column has therein listed possible beam prediction periods, and a third column has therein listed model parameter sets corresponding to the base station beam ranking sequences and the beam prediction periods.

TABLE 2-1

| Base station beam | Beam prediction | | Artificial intelligence |
|---|---|---|---|
| ranking sequence | period | | model parameter set |
| 1234 | 3 | ms | model parameter set S11 |
| 1234 | 10 | ms | model parameter set S12 |
| 1234 | 15 | ms | model parameter set S13 |
| 3412 | 3 | ms | model parameter set S21 |
| 3412 | 10 | ms | model parameter set S22 |
| 3412 | 15 | ms | model parameter set S23 |

| | | |
|---|---|---|
| . . . | . . . | . . . |

As can be seen from Table 2-1, the same base station beam ranking sequence may correspond to a plurality of model parameter sets S11-S13, which correspond to different beam prediction periods of 3 ms, 10 ms, and 15 ms, respectively.

In some embodiments, in the data table, a correspondence between different spatial regions and the artificial intelligence models may also be maintained. These spatial regions are obtained, for example, by pre-dividing a range covered by the network device.

Table 2-2 below shows a portion of another exemplary data table maintained by the base station. Table 2-2 differs from Table 2-1 in that it takes into account different spatial regions. A first column in table 2-1 has therein listed all possible base station beam ranking sequences, a second column has therein listed possible spatial regions, and a third column has therein listed model parameter sets corresponding to the base station beam ranking sequences and the spatial regions.

As shown in Table 2-2, the same base station beam ranking sequence may correspond to a plurality of model parameter sets S11-S13, which correspond to different spatial regions, respectively. The spatial region may be described using GPS coordinates or data based on a positioning reference signalling (PRS).

TABLE 2-2

| Base station beam | | Artificial intelligence |
|---|---|---|
| ranking sequence | Spatial Region | model parameter set |
| 1234 | region 1 | model parameter set S11 |
| 1234 | region 2 | model parameter set S12 |
| 1234 | region 3 | model parameter set S13 |
| 3412 | region 4 | model parameter set S21 |
| 3412 | region 5 | model parameter set S22 |
| 3412 | region 6 | model parameter set S23 |
| . . . | . . . | . . . |

In this case, the base station can determine a spatial location of the UE, and determine an artificial intelligence model for beam prediction for the UE based on the spatial location of the UE and the base station beam ranking sequence. The base station may determine the spatial location of the UE based on GPS or based on the positioning reference signalling (PRS), and determine whether the determined spatial location of the UE falls within a certain region, thereby finding a corresponding model parameter set from the data table. Those skilled in the art can appreciate that the above is merely an exemplary illustration of the data table. Those skilled in the art can design as needed a data table where more or different factors are taken into account.

For example, the data table may contain base station beam ranking sequences, spatial regions and beam prediction periods.

For another example, in addition to the base station beam ranking sequence, a difference between intensities of the beams included in the base station beam ranking sequence may be taken into account. For the same base station beam ranking sequence, if the difference between the intensities of the beams is less than an intensity difference threshold, one artificial intelligence model may be used, and if the difference between the intensities of the beams is greater than or equal to the intensity difference threshold, another artificial intelligence model may be used.

Those skilled in the art can appreciate that, the base station beam ranking sequence is not limited to the forms shown in Table 1, Table 2-1, and Table 2-2. As long as the base station beam ranking sequence can indicate the contained beams and the magnitude relationship between the intensities of the beams.

The method 200 further includes a step 2003, in which indication information associated with the determined artificial intelligence model is sent to the UE.

The indication information associated with the determined artificial intelligence model may include at least one of: the determined artificial intelligence model; the model parameter set of the determined artificial intelligence model; and an indicator of the determined artificial intelligence model.

The indication information may be sent to the UE via RRC signaling or high-layer signaling or DCI indication.

In some embodiments, the network device may generate RRC signaling containing information for indicating an alternative artificial intelligence model, and send the RRC signaling to the UE.

In some cases, the RRC signaling may contain a plurality of alternative artificial intelligence models. The network device may generate a MAC control element or DCI for indicating one of the plurality of alternative artificial intelligence models, and send the MAC control element or DCI to the UE.

FIG. 2B is a flow diagram illustrating an exemplary method 201 performed by a network device according to an embodiment of the present disclosure.

As shown in FIG. 2B, the method 201 may include a step 2011, in which a reported beam measurement result is received from the UE.

The method 201 further includes step 2013, in which information associated with a beam prediction period of the UE is received from the UE.

In some embodiments, the information associated with the beam prediction period of the UE includes a beam prediction period to be used by the UE. In still other embodiments, the information associated with the beam prediction period of the UE includes a reference signal measurement period of the UE. In still other embodiments, the information associated with the beam prediction period of the UE may include a receiving beam switching period of the UE. Those skilled in the art can appreciate that the information associated with the beam prediction period of the UE may include any information for determining the beam prediction period of the UE.

The method 201 further includes a step 2015, in which an artificial intelligence model for the UE is determined based on both the received beam measurement result and the information associated with the beam prediction period of the UE.

The method 201 further includes a step 2017, in which indication information associated with the determined artificial intelligence model is sent to the UE.

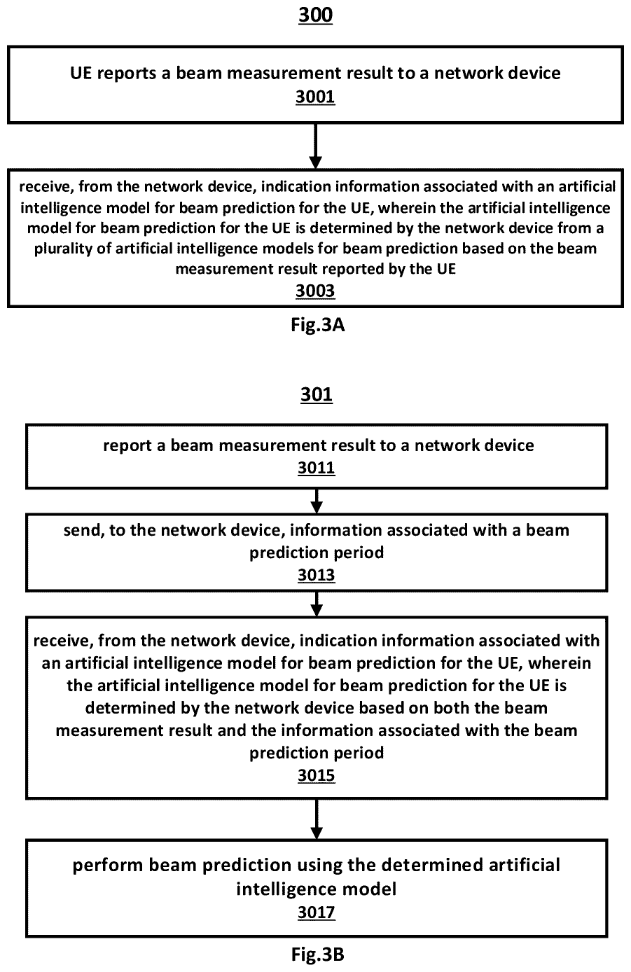

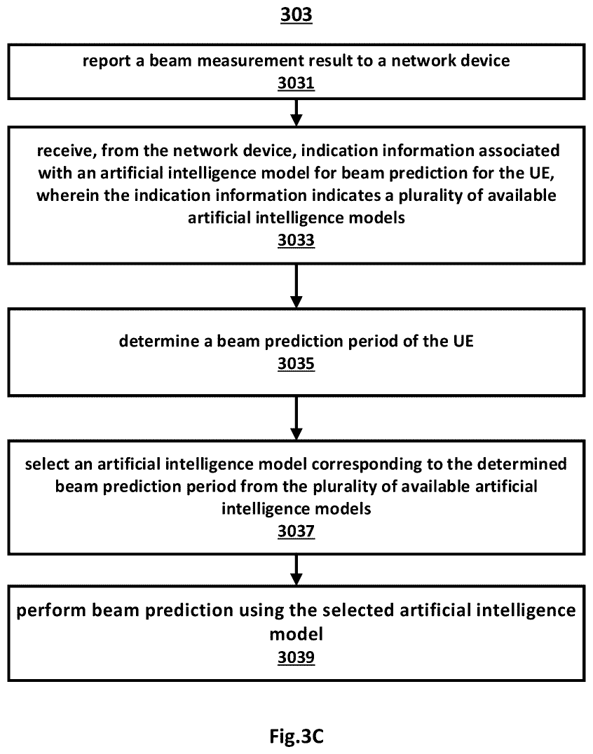

FIG. 3A is a flow diagram illustrating an exemplary method 300 performed by a UE according to an embodiment of the present disclosure.

As shown in FIG. 3A, the method 300 includes a step 3001, in which the UE reports a beam measurement result to a network device.

The method 300 can further include a step 3003, in which indication information associated with an artificial intelligence model for beam prediction for the UE is received from the network device, wherein the artificial intelligence model for beam prediction for the UE is determined by the network device from a plurality of artificial intelligence models for beam prediction based on the beam measurement result reported by the UE.

The UE may perform beam prediction using the indicated artificial intelligence model. In some embodiments, the beam prediction is performed between two pre-configured beam measurements using the artificial intelligence model indicated by the indication information, and transmission is made using the predicted beam. That is, transmission is made directly using the beam predicted by the artificial intelligence model. For example, when a moving velocity of a terminal exceeds a threshold, the beam prediction based on the artificial intelligence model can be inserted between two pre-configured beam measurements to achieve more timely beam replacement.

In other embodiments, the beam prediction is performed between two pre-configured beam measurements using the artificial intelligence model indicated by the indication information, and one or more predicted beams are preferentially measured in a next beam measurement. That is, the beam prediction result is not used directly for transmission, but for optimizing the next beam measurement. Normally, the UE needs to perform scanning for a plurality of receiving beams each time it performs a receiving beam measurement. In contrast, by preferentially measuring one or more predicted beams using the beam prediction result, a receiving beam meeting the requirement can be found more quickly, thereby saving expense of the receiving beam measurement, and achieving more efficient receiving beam switching.

In some embodiments, the UE may determine whether to perform the beam prediction using the artificial intelligence model according to at least one of a moving velocity of the UE, a current communication link quality, or a transmission business requirement. The current communication link quality may be determined, for example, based on parameters such as a channel quality indicator (CQI), a reference signal receiving power (RSRP), and a reference signal receiving quality (RSRQ). This enables faster beam switching for business with a high communication quality requirement.

FIG. 3B is a flow diagram illustrating an exemplary method 301 performed by a UE according to an embodiment of the present disclosure.

As shown in FIG. 3B, the method 301 includes a step 3011, in which the UE reports a beam measurement result to a network device.

As shown in FIG. 3B, the method 301 includes a step 3013, in which information associated with a beam prediction period is sent to the network device.

In some embodiments, the UE may send, to the network device, a request for an artificial intelligence model for beam prediction. The information associated with the beam prediction period may be included in the request.

The method 300 may further include a step 3015, in which indication information associated with an artificial intelligence model for beam prediction for the UE is received from the network device, wherein the artificial intelligence model for beam prediction for the UE is determined by the network device based on both the beam measurement result and the information associated with the beam prediction period.

The method 300 may further include a step 3017, in which the UE performs beam prediction using the determined artificial intelligence model.

FIG. 3C is a flow diagram illustrating a method 303 performed by a UE according to an embodiment of the present disclosure.

As shown in FIG. 3C, the method 303 includes a step 3031, in which the UE reports a beam measurement result to a network device.

The method 303 may further include a step 3033, in which indication information associated with an artificial intelligence model for beam prediction for the UE is received from the network device, wherein the artificial intelligence model for beam prediction for the UE is determined by the network device from a plurality of artificial intelligence models based on the beam measurement result reported by the UE, and the indication information associated with the artificial intelligence model for beam prediction for the UE indicates a plurality of alternative artificial intelligence models.

For example, a base station may determine a set of artificial intelligence models available to the UE based on the beam measurement result reported by the UE. Each model in the set of artificial intelligence models may be associated with a different beam prediction period.

The base station may send, to the UE, a model parameter set of the set of artificial intelligence models. In the case where the set of artificial intelligence models is pre-stored at the UE, only an indicator of the set of artificial intelligence models may be sent to the UE. In some embodiments, the base station may also send the set of artificial intelligence models to the UE.

The indication information may be transmitted via RRC signaling or high-layer signaling or DCI indication.

Although not shown, in some embodiments, the UE may receive RRC signaling containing information for indicating an alternative artificial intelligence model. In other embodiments, the RRC signaling may contain a plurality of alternative artificial intelligence models, and the UE may receive a MAC control element or downlink control information (DCI) for indicating one of the plurality of alternative artificial intelligence models.

The method 303 may include a step 3035, in which the UE determines a beam prediction period of the UE.

The UE may trigger the determination of the beam prediction period of the UE in response to a link quality change velocity exceeding a threshold, or a frequency of link measurement failures exceeding a frequency threshold, or a moving velocity exceeding a velocity threshold, or the like (which means that the UE needs frequent measurements of the reference signal and timely replacement of the received beam).

The UE may determine the beam prediction period based on the current link quality change velocity or the frequency of link quality measurement failures. The UE may also determine the beam prediction period based on its own moving velocity. The UE may also determine the beam prediction period based on the receiving beam switching period of the UE.

The beam prediction period may be associated with a reference signal measurement period that is required without prediction. For example, the beam prediction period may be less than or equal to a minimum reference signal measurement period that is required to ensure the communication quality without prediction.

The beam prediction period may also be less than or equal to the receiving beam switching period. For example, the UE finds that the receiving beam shall be changed every 10 ms based on periodic measurements, then the beam prediction period may be determined to be 10 ms or less.

The method 303 may include a step 3037, in which the UE selects an artificial intelligence model corresponding to the determined beam prediction period from the plurality of alternative artificial intelligence models, as the artificial intelligence model for beam prediction for the UE.

The method 303 may include a step 3039, in which the UE performs beam prediction using the selected artificial intelligence model.

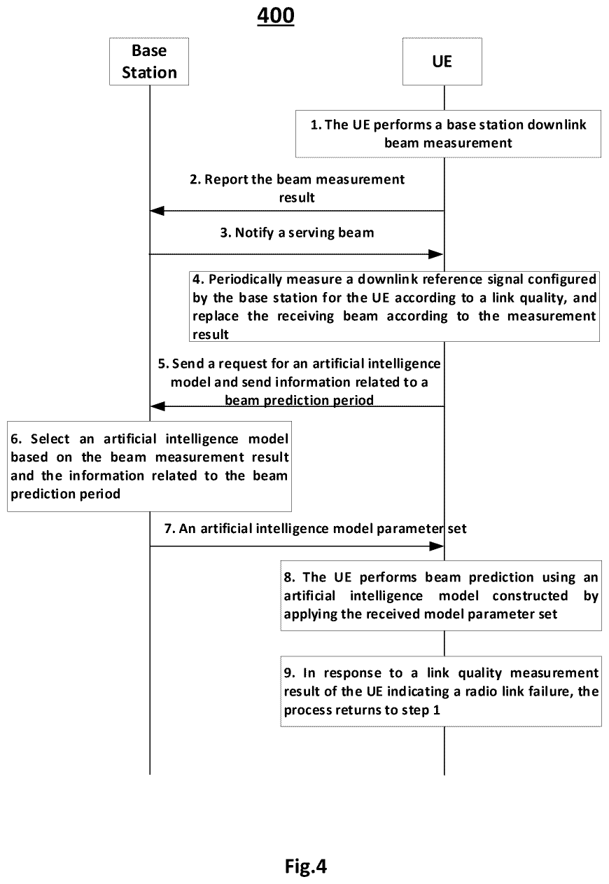

FIG. 4 is a flow diagram illustrating an exemplary communication process 400 between a base station and a UE according to an embodiment of the present disclosure.

As shown in the figure, the process 400 includes a step 1, in which the UE performs a base station downlink beam measurement.

The measurement may be based on an SSB or a CSI-RS.

In some embodiments, the base station sequentially transmits a set of reference signals on a plurality of transmitting beams, and the UE may receive the set of reference signals using one receiving beam, and determine intensities of base station downlink beams based on receiving intensities of the reference signals. The UE may rank the intensities of the base station downlink beams, to obtain a beam intensity-based base station downlink beam ranking sequence.

In other embodiments, the UE may measure intensities of base station downlink beams using all beams, and average the intensities of the base station downlink beams that are measured by all the beams. The UE may rank the average intensities of the base station downlink beams in a descending order, to obtain a beam intensity-based base station downlink beam ranking sequence.

The process 400 may include a step 2, in which the UE reports the beam measurement result to the base station.

The beam measurement result may include beam intensity-based base station beam measurement information, for example, the beam intensity-based base station beam ranking sequence or information for determining the beam intensity-based base station beam ranking sequence.

The beam measurement result may include the beam intensity-based base station beam ranking sequence measured by the UE. Assuming that the base station uses 4 beams labeled 1, 2, 3, and 4, and that a reporting instance of the beam measurement result can be reported for 4 reference signals, then the beam measurement result may include, for example, a base station beam ranking sequence such as 4321 and 1324, where 4321 may indicate that the beam 4 has the highest intensity and the beam 3, beam 2, and beam 1 have sequentially descending intensities.

The base station downlink beam ranking sequence may further include only indexes of a strongest base station beam and several secondary strong base station beams. For example, if the base station uses 8 beams labeled 1-8 while a reporting instance of the beam measurement result can be reported for 4 reference signals, the beam measurement result can include a base station beam ranking sequence such as 7856 and 4321, where 7856 can indicate that among the 8 base station beams, the beam 7 is the strongest, the beam 8, beam 5, and beam 6 are 3 secondary strong beams and have sequentially descending intensities.

In some embodiments, the beam measurement result may include only the information for determining the beam intensity-based base station beam ranking sequence. For example, the beam measurement result may include identifiers of the reported beams, L1-RSRP of the strongest beam, and differences between L1-RSRPs of the three secondary strong beams and the strongest beam. The base station may learn the beam intensity-based base station beam ranking sequence based on the beam measurement result.

The process 400 may further include a step 3, in which the base station notifies, to the UE, a serving beam used by the base station.

The base station may select the strongest beam as the serving beam according to the beam measurement result reported by the UE, or select another beam as the serving beam.

It can be appreciated that the UE can determine an initial receiving beam according to the serving beam indicated by the base station. For example, a receiving beam having a maximum reference signal receiving intensity corresponding to the serving beam when the base station downlink beam is measured may be taken as the initial receiving beam paired with the serving beam.

The process 400 may further include a step 4, in which the UE periodically measures a downlink reference signal configured by the base station for the UE according to its own link quality, and replaces the receiving beam according to the measurement result.

At this time, the base station's transmitting beam is not changed, the UE might move and/or rotate with the movement of the user, and the UE may periodically measure the reference signal sent by the base station according to its own link quality, and replace the receiving beam according to the measurement result.

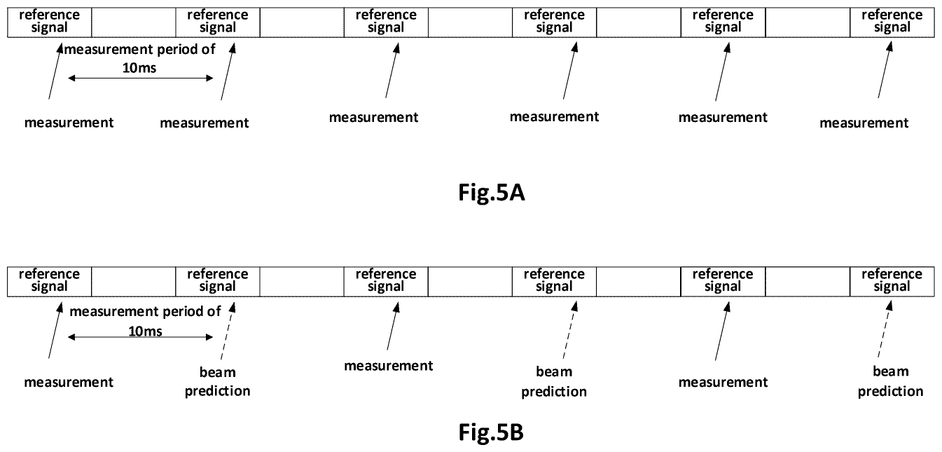

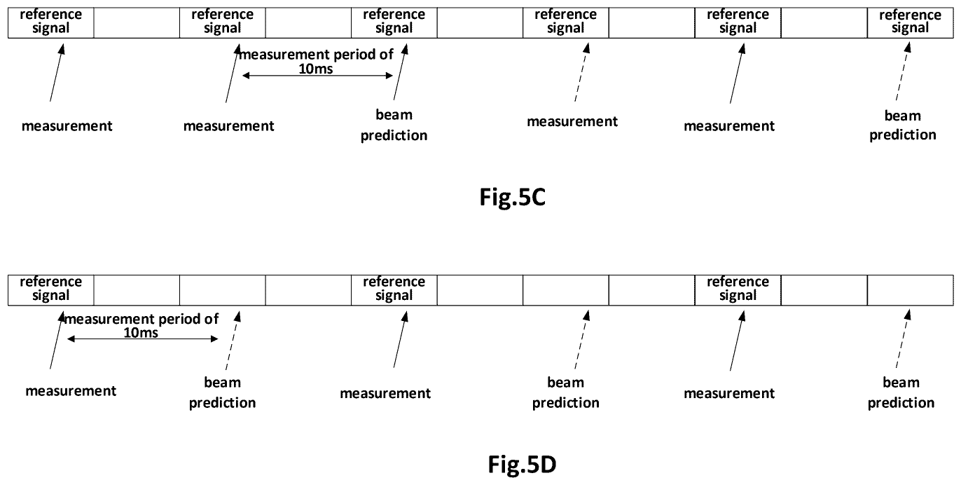

FIG. 5A is a schematic diagram illustrating a UE periodically measuring a reference signal sent by a base station. As shown in FIG. 5A, the UE periodically (e.g., one measurement every 10 ms) measures the reference signal sent by the base station.

The reference signal is, for example, an SSB or a CSI-RS. If the UE moves at a higher velocity, it might cause a rapid change in link quality, thereby needing to measure the reference signal and replace the receiving beam at a higher frequency (smaller period), enabling the UE to make a timely decision to replace the receiving beam. When the UE moves at a slower velocity or does not move, the reference signal may be measured at a lower frequency (larger period).

The process 400 may further include a step 5, in which the UE sends a request for an artificial intelligence model and sends information related to a beam prediction period, to the base station.

In some embodiments, the UE may send a request for an artificial intelligence model and send information related to a beam prediction period to the base station, in response to the receiving beam replacement period being less than a threshold period or a frequency of link quality measurement failures being greater than a threshold frequency.

In other embodiments, the UE may send a request for an artificial intelligence model and send information related to a beam prediction period to the base station, in response to a moving velocity exceeding a velocity threshold.

The information related to the beam prediction period may include a beam prediction period determined by the UE.

In some embodiments, the UE may determine the beam prediction period according to the receiving beam replacement period. For example, the UE finds that receiving beam changes once every 10 ms, then it may be determined that the receiving beam replacement period is 10 ms, thereby determining that the required beam prediction period is 10 ms.

In other embodiments, the UE may determine the prediction period according to a frequency of link quality measurement failures. For example, if the frequency of link quality measurement failures is 5 failures per minute, it may be determined that the prediction period is 100 ms or 80 ms.

In still other embodiments, the beam prediction period may be determined according to the moving velocity of the UE.

The beam prediction period can be designed as needed by those skilled in the art, as long as it can meet the requirement of the communication quality.

In some embodiments, the information related to the beam prediction period may include information for determining the beam prediction period. For example, the UE may send, to the base station, the information for determining the beam prediction period, such as the receiving beam replacement period, the frequency of link quality measurement failures, and the moving velocity of the UE, and the base station determines the beam prediction period based on such information. In this case, when the base station sends, to the UE, indication information of a determined artificial intelligence model, information related to the determined beam prediction period shall be included.

The process 400 may further include a step 6, in which in response to the request, the base station selects an artificial intelligence model based on the beam measurement result and the information related to the beam prediction period.

The base station may maintain a data table representing a correspondence between beam measurement results, beam prediction periods, and artificial intelligence models, for example, as shown in Table 2-1. The base station may select the corresponding artificial intelligence model based on both the beam measurement result and the beam prediction period.

The process 400 may further include a step 7, in which the base station sends a model parameter set of the selected artificial intelligence model to the UE.

In some embodiments, on the UE side, basic data enabling the artificial intelligence model may have already been pre-stored, in which case, the base station may send only the model parameter set of the selected artificial intelligence model to the UE. The UE uses the received model parameter set to construct an artificial intelligence model to be used.

In some embodiments, the UE might have already pre-stored all possible artificial intelligence model parameter sets, in which case, the base station may send only an identifier of the artificial intelligence model to the UE.

In some embodiments, the UE might not store relevant data for constructing the artificial intelligence model, then the base station can send the artificial intelligence model to the UE for constructing the corresponding artificial intelligence model on the UE side.

The process 400 may further include a step 8, in which the UE performs beam prediction using an artificial intelligence model constructed by applying the received model parameter set.

FIGS. 5B and 5C are schematic diagrams illustrating beam prediction according to an embodiment of the present disclosure. FIG. 5B illustrates making one measurement and one prediction, and FIG. 5C illustrates making two measurements and one prediction. In comparison with FIG. 5A, in FIGS. 5B and 5C, when the beam prediction is used, some of measurements that would otherwise be actually performed can be replaced with the beam prediction, to reduce the number of measurements that actually occur.

FIG. 5D is a schematic diagram illustrating another beam prediction according to an embodiment of the present disclosure. FIG. 5D illustrates that between two measurements, one prediction is inserted, during which the base station does not send a reference signal. In comparison with FIG. 5B, when the beam prediction is used, the base station may reduce the actually sent reference signals, e.g., CSI-RS, and the UE may reduce the actual measurements by using the beam prediction.

In the case where the base station transmits SSB as the reference signal to the UE, the UE may reduce actual measurements of the SSB by using the beam prediction, for example, as shown in FIGS. 5B and 5C.

In the case where the base station transmits CSI-RS as the reference signal to the UE, the UE may notify the base station of a beam prediction period before performing the beam prediction, and the base station may reduce sending of the CSI-RS based on the beam prediction period. In this case, both the base station and the UE can save power consumption and save communication resources.

The beam prediction period may refer to a duration from a latest measurement to the prediction. For example, in FIGS. 5B, 5C, and 5D, the beam prediction period is 10 ms. Those skilled in the art can appreciate that the beam prediction period may be adjusted according to design requirements.

The process 400 may further include a step 9, in which in response to a link quality measurement result of the UE indicating a radio-link failure (RLF), the process 400 may return to the step 1.

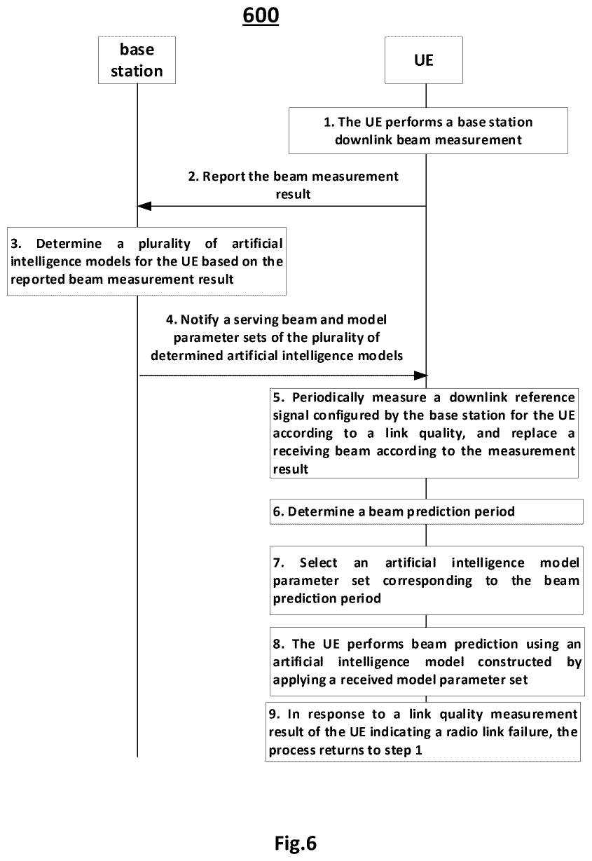

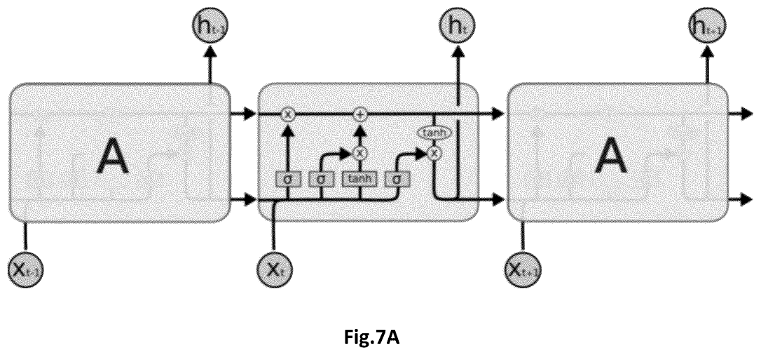

FIG. 6 is a flow diagram illustrating a communication process 600 between a base station and a UE according to an embodiment of the present disclosure.

As shown in FIG. 6, the process 600 include a step 1, in which the UE performs a base station downlink beam measurement. The measurement may be based on an SSB or a CSI-RS.

The process 600 may include a step 2, in which the UE reports the beam measurement result to the base station.

The process 600 may include a step 3, in which the base station determines a plurality of artificial intelligence models for the UE based on the reported beam measurement result.

The process 400 may further include a step 4, in which the base station notifies the UE of a serving beam used by the base station and model parameter sets of the determined plurality of artificial intelligence models. The base station may select a strongest beam as the serving beam according to the beam measurement result reported by the UE, and may also select another beam as the serving beam. The model parameter sets of the determined plurality of artificial intelligence models may be sent to the UE, along with the notification of the serving beam, via RRC signaling or high-layer signaling or DCI indication.

The process 600 may further include a step 5, in which the UE periodically measures a downlink reference signal configured by the base station for the UE according to its own link quality, and replaces the receiving beam according to the measurement result.

The process 600 may further include a step 6, in which the UE determines a beam prediction period. For example, the UE may determine the beam prediction period according to a receiving beam replacement period or a frequency of link quality measurement failures or a moving velocity, or the like.

The process 600 may further include a step 7, in which the UE selects an artificial intelligence model parameter set corresponding to the beam prediction period from the plurality of artificial intelligence model parameter sets.

The process 600 may further include a step 8, in which the UE performs beam prediction using an artificial intelligence model constructed by applying a received model parameter set.

The process 600 may further include a step 9, in which in response to a link quality measurement result of the UE indicating a radio-link failure, the process returns to the step 1.

In some embodiments, the UE may perform the steps 6-8 when the receiving beam replacement period is less than a threshold period or the frequency of link quality measurement failures is greater than a threshold frequency.

In some embodiments, the step 5 may be omitted. The UE may determine the beam prediction period based on a moving velocity of the UE after receiving the artificial intelligence model parameter set from the base station, thereby selecting an artificial intelligence model associated with the determined beam prediction period.

The process 600 differs from the process 400 in that, the base station determines and distributes the artificial intelligence model not in response to the UE's request for the artificial intelligence model, but rather actively sends the model parameter set determined based on the beam measurement result while notifying the serving beam. The UE selects an appropriate model parameter set from the received model parameter sets to perform the beam prediction.

Although not shown, the UE may also report, to the base station, capability information, which indicates information of support of the UE for the artificial intelligence model for the beam prediction. For example, the base station may request the capability information from the UE. In response to the request, the UE sends the capability information to the base station.

### Training of Artificial Intelligence Model

### Basic Working Principle of LSTM

A recurrent neural network (RNN) is a neural network for processing sequence data. Long short-term memory (LSTM), which is a special RNN, mainly solves problems of gradient vanishing and gradient exploding in a long sequence training process. Compared to the normal RNN, the LSTM can have a better performance in a longer sequence.

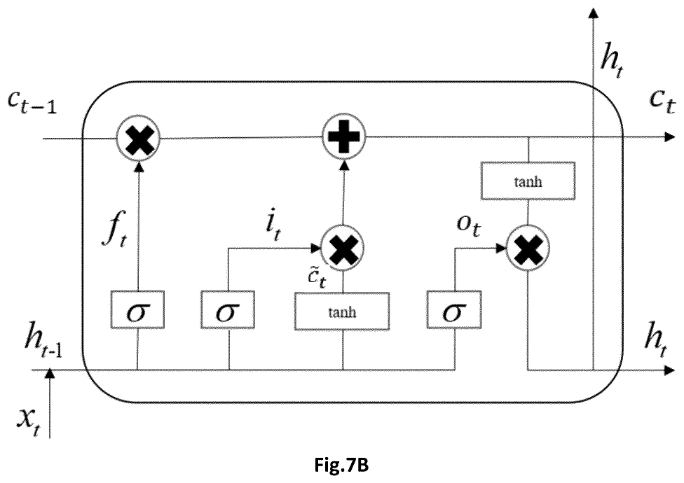

The LSTM is formed by a series of LSTM cells, which have a chain structure as shown in FIG. 7A. In the figure, a right-angle rectangular box represents one neural network layer, which is formed by a weight, bias and activation function. Each circle with an operation symbol represents an element level operation. An arrow represents a flow direction of a vector. An intersecting arrow represents concatenation of vectors. A diverging arrow represents replication of a vector. “A” represents the LSTM cell.

FIG. 7B illustrates an internal structure of an LSTM cell.

A main computational principle involved in the LSTM is shown in the following equations (1)-(6):

$${i}_{t} = σ ( {W}_{i} \cdot [ {h}_{t - 1} , {x}_{t} ] + {b}_{i} ) \qquad ( 1 )$$

$${\tilde{c}}_{t} = tanh ( {W}_{o} \cdot [ {h}_{t - 1} , {x}_{t} ] + {b}_{o} ) \qquad ( 2 )$$

$${f}_{t} = σ ( {W}_{f} \cdot [ {h}_{t - 1} , {x}_{t} ] + {b}_{f} ) \qquad ( 3 )$$

$${c}_{t} = {f}_{t}^{*} {c}_{t - 1} + {i}_{t}^{*} \qquad ( 4 )$$

$${o}_{t} = σ ( {W}_{o} \cdot [ {h}_{t - 1} , {x}_{t} ] + {b}_{o} ) \qquad ( 5 )$$

$${h}_{t} = {o}_{t}^{*} tanh ( {c}_{t} ) \qquad ( 6 )$$

where iₜ is an input gate, fₜ is a forget gate, and oₜ is an output gate; xₜ is an input signal at the current cell, cₜ is a memory state of the current cell, hₜ is an output state of the current cell, and \tilde{c}ₜ is an update memory state of the current cell. Wᵢ,W_{f},Wₒ,W_{c} are weight matrixes of input, forget, output and update states, respectively; bᵢ,b_{f},bₒ,b_{c} are bias values of input, forget, output, update states, respectively; σ is a mapping function of Sigmoid, and tanh is a mapping function of hyperbolic tangent.

Based on the illustrated LSTM structure, the artificial intelligence model may be defined by a model parameter set (Wᵢ,W_{f},Wₒ,W_{c},bᵢ,b_{f},bₒ,b_{c}).

Those skilled in the art can appreciate that the above illustration is only one example of the artificial intelligence model, and variations of the LSTM may be used, for example, LSTM with a peephole added on a gate, LSTM with a forget gate and an input gate integrated, gated recurrent unit (GRU), etc. Actually, any artificial intelligence model suitable for beam prediction may be used.

### Artificial Intelligence Model Training Based on Local Training Results of a Plurality of UEs

Training of an artificial intelligence model can be performed using a distributed machine learning framework. Federated learning is essentially such a distributed machine learning framework. A goal of the federated learning is to achieve co-modeling on the basis of ensuring data privacy safety and legal compliance, to improve an effect of an artificial intelligence model. The present disclosure may perform training of an artificial intelligence model based on the framework of the federated learning.

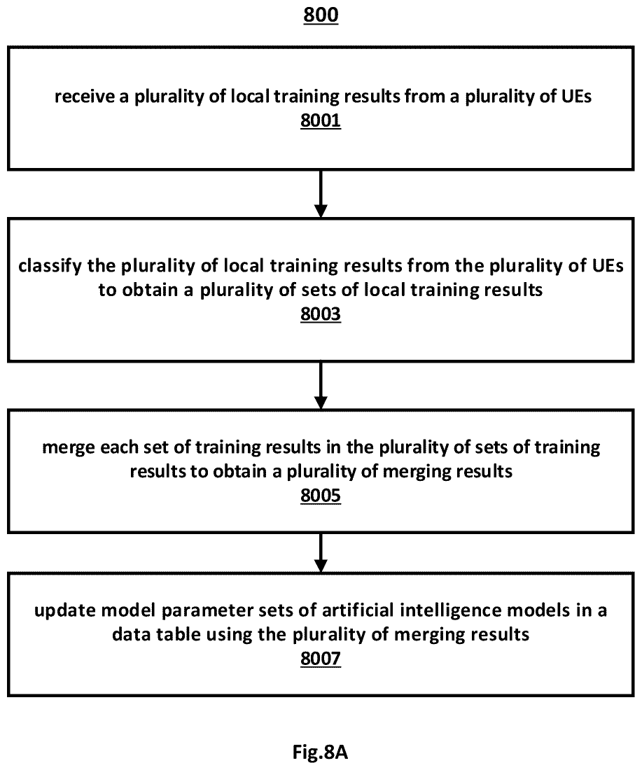

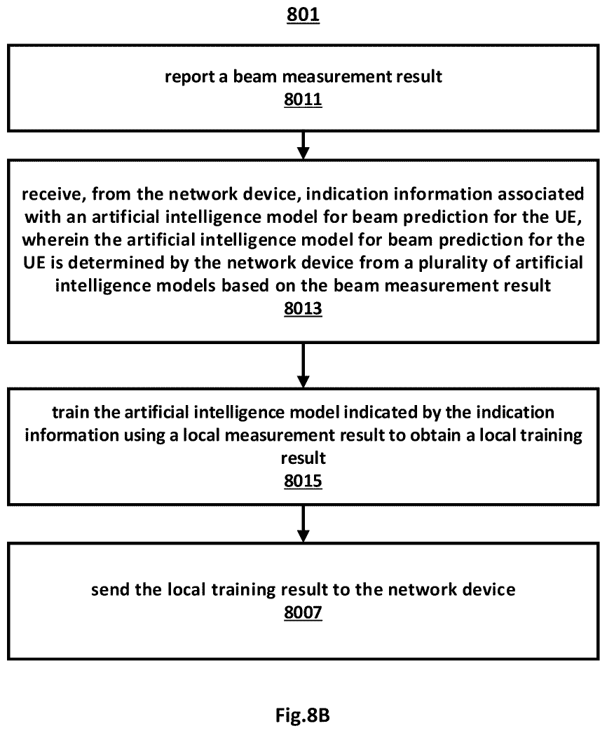

FIG. 8A is a flow diagram illustrating an exemplary method 800 performed by a network device according to an embodiment of the present disclosure. The network device may, by using a plurality of local training results from a plurality of UEs, update a data table maintained at a base station, and more particularly, update model parameter sets of artificial intelligence models in the data table.

As shown in FIG. 8A, the method 800 may include a step 8001, in which the network device receives the plurality of local training results from the plurality of UEs.

The local training result of each UE is obtained by the UE training a corresponding artificial intelligence model by using a local measurement result.

The local measurement result of each UE is obtained, for example, by the UE performing a periodic measurement on a reference signal configured by the base station and selecting a receiving beam based on the measurement result. The local measurement result of each UE may include at least reference signal measurement times and a receiving beam selection results corresponding to the reference signal measurement times.

In some embodiments, the network device may, for each UE of the plurality of UEs: according to a beam measurement result reported by the UE, send a model parameter set corresponding to the beam measurement result to the UE, for constructing an artificial intelligence model to be trained. The UE locally trains the artificial intelligence model constructed by the model parameter set received by an application using the local measurement result, thereby obtaining an updated model parameter set. The local training result may include the updated model parameter set.

The beam measurement result reported by the UE may be information related to an intensity-based base station beam ranking sequence. The network device may send one or more model parameter sets corresponding to the base station beam ranking sequence to the UE, according to the base station beam ranking sequence reported by the UE. Each model parameter set may also be associated with a corresponding beam prediction period. The UE may determine a beam prediction period for the training according to the local measurement result, and select a model parameter set corresponding to the determined beam prediction period from the one or more model parameter sets for constructing the artificial intelligence model to be trained. The UE obtains the updated model parameter set by training the constructed artificial intelligence model using the local measurement result. The local training result may include the updated model parameter set and the associated beam prediction period.

In other embodiments, the network device may pre-send all latest model parameter sets in the data table to the plurality of UEs for the local training. Each UE may select a model parameter set. For example, the UE may determine the intensity-based base station beam ranking sequence associated with the local measurement result, and determine the beam prediction period for the training based on the local measurement result, thereby selecting a model parameter set corresponding to both the intensity-based base station beam ranking sequence and the beam prediction period. The UE constructs the artificial intelligence model to be trained using the selected model parameter set, and trains the constructed artificial intelligence model using the local measurement result to obtain an updated model parameter set. The local training result may include the updated model parameter set and the associated beam prediction period and the associated base station beam ranking sequence.

As shown in FIG. 8A, the method 800 may further include a step 8003, in which the network device classifies the plurality of local training results from the plurality of UEs to obtain a plurality of sets of local training results.

In some embodiments, the plurality of local training results may be classified based on the base station beam ranking sequence, so that local training results corresponding to a same base station beam ranking sequence are classified into one set. In other embodiments, the plurality of local training results may be classified based on the base station beam ranking sequence and the beam prediction period, so that local training results corresponding to a same base station beam ranking sequence and to a same beam prediction period are classified into one set.

As shown in FIG. 8A, the method 800 may further include a step 8005, in which the network device merges each set of training results in the plurality of sets of training results to obtain a plurality of merging results. For example, each set of training results may be averaged, and the average value is taken as the merging result, i.e. an updated model parameter set.

As shown in FIG. 8A, the method 800 may further include a step 8007, in which the network device updates a data table using the plurality of merging results, for example, updates model parameter sets of artificial intelligence models in the data table. The network device may replace previous model parameter sets in the data table with the updated model parameter sets.

FIG. 8B is a flow diagram illustrating an exemplary method 801 performed by a UE according to an embodiment of the present disclosure.

As shown in FIG. 8B, the method 801 includes a step 8011, in which the UE reports a beam measurement result to a network device (e.g., a base station).

The method 801 includes a step 8013, in which the UE receives, from the network device, indication information associated with an artificial intelligence model for beam prediction for the UE, wherein the artificial intelligence model for beam prediction for the UE is determined by the network device from a plurality of artificial intelligence models based on the beam measurement result.

The indication information associated with the artificial intelligence model for beam prediction for the UE may be an artificial intelligence model to be trained by the UE, or a latest model parameter set of an artificial intelligence model to be trained by the UE.

The method 801 includes a step 8015, in which the UE trains the artificial intelligence model indicated by the indication information using a local measurement result to obtain a local training result, wherein the local training result comprises an updated model parameter set of the artificial intelligence model indicated by the indication information and a beam prediction period.

The method 801 includes a step 8017, in which the UE sends the local training result to the network device.

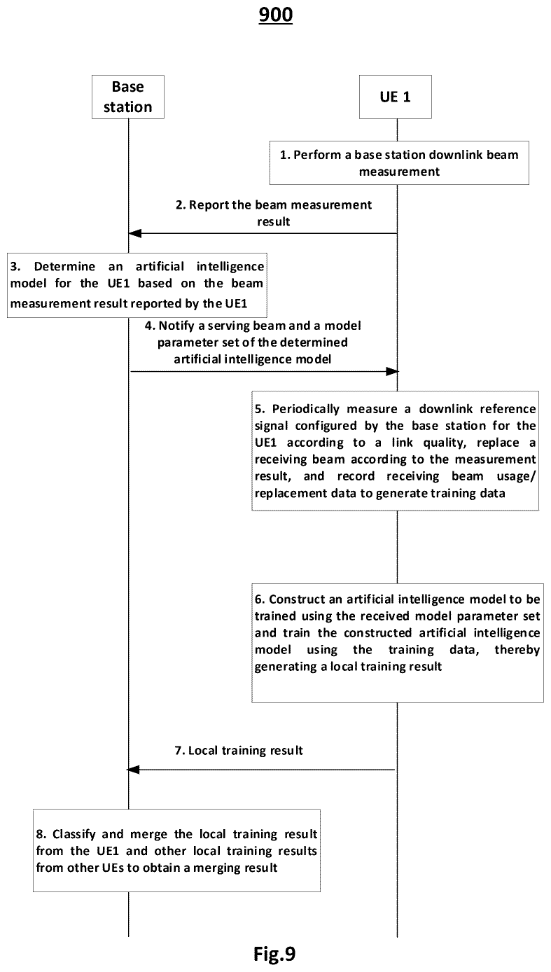

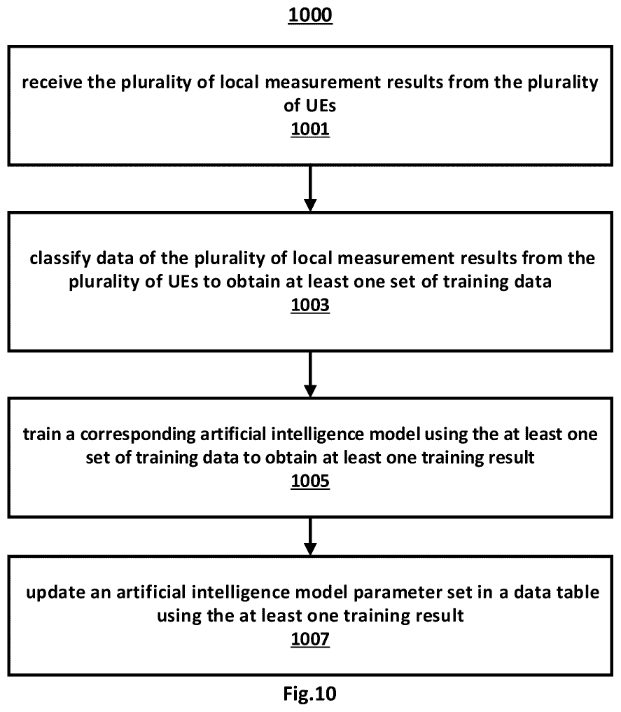

FIG. 9 is a flow diagram illustrating an example communication process 900 performed by a base station and one of a plurality of UEs according to an embodiment of the present disclosure. For ease of illustration, only a UE1 of the plurality of UEs is illustrated here.

As shown in FIG. 9, the process 900 may include a step 1, in which the UE1 performs a base station downlink beam measurement.

The process 900 may include a step 2, in which the UE1 reports the beam measurement result to the base station.

The process 900 may include a step 3, in which the base station determines an artificial intelligence model for the UE1 based on the reported beam measurement result.

The process 900 may include a step 4, in which the base station notifies the UE1 of a serving beam used by the base station and model parameter sets of a plurality of determined artificial intelligence models. The model parameter sets of the plurality of determined artificial intelligence models may be a latest model parameter set of an artificial intelligence model to be trained by the UE 1.

The process 900 may include a step 5, in which the UE1 periodically measures a downlink reference signal configured by the base station for the UE1 according to its own link quality, replaces a receiving beam according to the measurement result, and records a local measurement result. The local measurement result may comprise at least reference signal measurement times and corresponding receiving beam selection results.

The UE periodically measures the reference signal sent by the network device, and records the measurement times and the receiving beam selection results corresponding to the measurement times as labeled training data.

Assume that the network device uses beams 1-4 and each UE uses receiving beams A, B, C and D. Assuming that a base station beam ranking sequence reported by one UE is 4321, the local measurement result recorded by the UE in the process of performing reference signal measurement may be as shown in Table 3:

TABLE 3

| Measurement | Receiving beam |
|---|---|
| time | actually used by UE |
| T1 | A |
| T2 | A |
| T3 | B |
| T4 | B |
| . . . | . . . |

The process 900 may include a step 6, in which the UE1 constructs an artificial intelligence model to be trained using the received model parameter set and trains the constructed artificial intelligence model using the local measurement result, thereby generating a local training result.

For example, a measurement period and a suitable beam prediction period for the training may be determined according to the measurement time information and the receiving beam selection result corresponding to the measurement times (which may reflect receiving beam replacement information).

The UE may select a model parameter set according to the determined beam prediction period for the training and construct the artificial intelligence model to be trained using the selected model parameter set.

The UE may train, for example, an LSTM-based artificial intelligence model, using a receiving beam ranking sequence shown in Table 3. Receiving beam data “AA” at times T1, T2 may be used as an input to the model, and an output of the model may be compared with “B” at a time T3. Based on a difference between the model output and the measurement result, the artificial intelligence model can be optimized, thereby obtaining an updated model parameter and an updated model parameter set. The model optimization may be based on, for example, an Adam algorithm (see Kingma, Diederik, and Jimmy Ba. “Adam: A method for stochastic optimization.” arXiv preprint arXiv:1412.6980 (2014)).

The UE may train different artificial intelligence models respectively by using data corresponding to different measurement periods in the local measurement result, thereby obtaining different model parameter sets.

The process 900 may include a step 7, in which the UE1 sends the local training result to the base station.

The local training result that the UE may report to the base station may be, for example, as shown in Table 4:

TABLE 4

| Model parameter set | Beam prediction period | |
|---|---|---|
| S11 | 1 | ms |
| S12 | 2 | ms |
| S13 | 10 | ms |

Table 4 may further include a corresponding base station beam intensity ranking 4321. Since the UE has previously reported the base station beam ranking to the base station, Table 4 may also not include this information.

The process 900 may include a step 8, in which the base station classifies and merges the local training result from the UE1 and other local training results from other UEs to obtain a merging result.

The processing of classification and merging is similar to the steps 8003 and 8005 in FIG. 8, so that it will not be repeated here.

FIG. 9 only illustrates the communication process between the base station and the UE1, and it can be understood that for other UEs, steps similar to the steps 1-7 are executed between the base station and each other UE, thereby obtaining a local training result of the other UE.

In some embodiments, each UE may send, to the base station, a local prediction result generated in the process of locally training the artificial intelligence model, and the base station may process the local prediction results from the plurality of UEs and send the processing result to each UE, to help optimize the local training at each UE. For example, for the same prediction, for example, in the case of a same base station beam ranking sequence and a same beam prediction period, a receiving beam at a next time is predicted based on the known receiving beam selection sequence “AA”, and local prediction results of most UEs in the plurality of UEs all show that the receiving beam at the next time is A, then it may be considered that those local prediction results showing that the receiving beam at the next time is not A are incorrect, and the base station may send the correct local prediction result to those UEs reporting the incorrect local prediction result, so that these UEs may optimize or adjust the training of the artificial intelligence model by using the received correct local prediction result.

### Artificial Intelligence Model Training Based on Local Measurement Results of a Plurality of UEs

FIG. 10 is a flow diagram illustrating a method 1000 performed by a base station according to an embodiment of the present disclosure. The base station trains a plurality of artificial intelligence models at the base station using a plurality of local measurement results from a plurality of UEs as training data, to obtain updated model parameter sets.

As shown in FIG. 10, the method 1000 includes a step 1001, in which the base station receives the plurality of local measurement results from the plurality of UEs, each local measurement result comprising at least reference signal measurement times and receiving beam selection results corresponding to the reference signal measurement times.

The local measurement result may be as shown in Table 3. It can be appreciated that the base station may have already known a base station beam ranking sequence corresponding to each local measurement result. The base station may determine a beam prediction period for training according to the reference signal measurement times and the receiving beam selection result corresponding to the reference signal measurement times.

In some embodiments, the local measurement result may also contain information about the corresponding base station beam ranking sequence and the beam prediction period.

The method 1000 may further include a step 1003, in which the base station classifies data of the plurality of local measurement results from the plurality of UEs to obtain at least one set of training data. The classification may be based on the base station beam ranking sequence or on both the base station beam ranking sequence and the beam prediction period.

The method 1000 may further include a step 1005, in which a corresponding artificial intelligence model is trained using the at least one set of training data, to obtain at least one training result.

In some embodiments, measurement result data corresponding to a same base station beam ranking sequence included in the plurality of local measurement results may be classified together as a set of training data, to train an artificial intelligence model corresponding to the base station beam ranking sequence to obtain an updated model parameter set corresponding to the base station beam ranking sequence. In other embodiments, measurement result data included in the plurality of local measurement results corresponding to a same base station beam ranking sequence and to a same beam prediction period may be classified together as a set of training data, to train an artificial intelligence model corresponding to the base station beam ranking sequence and to the beam prediction period, to obtain an updated model parameter set corresponding to the base station beam ranking sequence and to the beam prediction period.

The method 1000 may further include a step 1007, in which a data table, for example, an artificial intelligence model parameter set in the data table, is updated using the at least one training result.

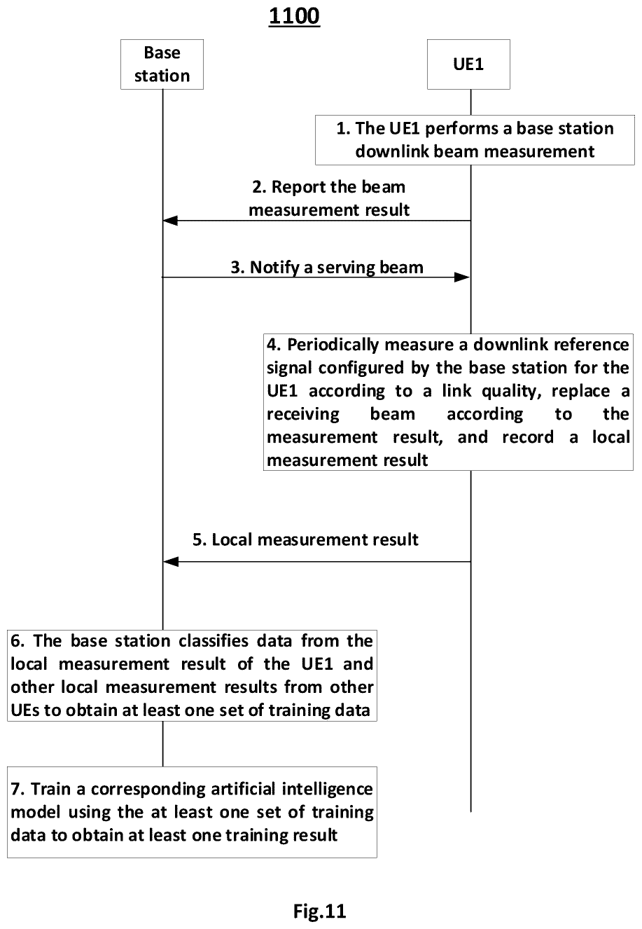

FIG. 11 is a flow diagram illustrating an example communication process 1100 performed by a base station and one of a plurality of UEs according to an embodiment of the present disclosure. For ease of illustration, only a UE1 of the plurality of UEs is illustrated here.

As shown in FIG. 11, the process 1100 may include a step 1, in which the UE1 performs a base station downlink beam measurement.

The process 1100 may include a step 2, in which the UE1 reports the beam measurement result to the base station.

The process 1100 may include a step 3, in which the base station notifies the UE1 of a serving beam used by the base station.

The process 1100 may include a step 4, in which the UE1 periodically measures a downlink reference signal configured by the base station for the UE1 according to its own link quality, replaces a receiving beam according to the measurement result, and records a local measurement result. The local measurement result may comprise at least reference signal measurement times and corresponding receiving beam selection results.

The process 1100 may include a step 5, in which the UE1 sends the local measurement result to the base station.

The process 1100 may include a step 6, in which the base station classifies data from the local measurement result of the UE1 and other local measurement results from other UEs to obtain at least one set of training data.

The process 1100 may include a step 7, in which the base station trains a corresponding artificial intelligence model using the at least one set of training data, to obtain at least one training result.

FIG. 11 only illustrates a communication process between a base station and a UE1, and it can be understood that for other UEs, steps similar to the steps 1-5 are performed between the base station and each other UE, thereby obtaining local measurement results of the other UEs.

The training of the artificial intelligence model is described above in consideration of the two factors: the base station beam intensity ranking and the beam prediction period. Those skilled in the art can appreciate that when an additional factor (e.g., a spatial region) needs to be considered, a training method for the artificial intelligence model is similar.

For example, in case of considering a spatial region, the UE additionally records a spatial location corresponding to the measurement performed by the UE. The base station may transmit a corresponding training model parameter set based on both the spatial location and the base station beam intensity ranking sequence reported by the UE.

In the case of artificial intelligence model training based on local training results of a plurality of UEs, the local training result is associated with the spatial location. The spatial locations of the plurality of UEs are used by the base station to classify the local training results of the plurality of UEs.

In the case of artificial intelligence model training based on local measurement results of a plurality of UEs, the local measurement result of the UE may contain the spatial location of the UE. The spatial locations of the plurality of UEs are used by the base station to classify the local measurement results of the plurality of UEs.

According to the embodiment of the present disclosure, the artificial intelligence model for beam prediction for the UE is determined and distributed based on the beam measurement result reported by the UE, achieving accurate artificial intelligence model distribution.

According to the embodiment of the present disclosure, different artificial intelligence models corresponding to different radio propagation environments and/or different beam prediction periods and/or different spatial regions are trained by using the local measurement results of the plurality of UEs, assisting in the accurate artificial intelligence model distribution.

The accurate artificial intelligence model distribution enables the UE to achieve efficient beam prediction, reducing the number of beam measurements while maintaining good communication quality, and lowering the power consumption of the UE.

An electronic device and a communication method according to some embodiments of the present disclosure are described below.

### [Exemplary Implementations of the Present Disclosure]

According to the embodiments of the present disclosure, various implementations of implementing the concepts of the present disclosure can be contemplated, including but not limited to:

1) A method performed by a network device, comprising:
determining an artificial intelligence model for a user equipment (UE) from a plurality of artificial intelligence models for beam prediction based on a beam measurement result reported by the UE; and
sending, to the UE, indication information associated with the determined artificial intelligence model.

2) The method of item 1), wherein the beam measurement result reported by the UE comprises a beam intensity-based base station beam ranking sequence.

3) The method of item 1), further comprising:
receiving, from the UE, information associated with a beam prediction period of the UE; and
determining the artificial intelligence model for beam prediction for the UE based on both the beam measurement result and the information associated with the beam prediction period of the UE.

4) The method of item 1), further comprising:
determining a spatial location of the UE, and
determining the artificial intelligence model for beam prediction for the UE based on the spatial location of the UE.

5) The method of item 1), further comprising sending, to the UE, the indication information associated with the determined artificial intelligence model via at least one of:
RRC signaling; or
high-layer signaling; or
DCI indication.

6) The method of item 1), further comprising:
receiving, from the UE, a request for the artificial intelligence model for beam prediction.

7) The method of item 1), further comprising:
receiving, from the UE, capability information, which indicates information of support of the UE for the artificial intelligence model for beam prediction.

8) The method of item 1), wherein each artificial intelligence model is defined by one model parameter set, the method further comprising:
maintaining a data table, wherein the data table comprises at least:
   beam intensity-based base station beam ranking sequences and corresponding artificial intelligence model parameter sets; or
   the beam intensity-based base station beam ranking sequences, beam prediction periods, and corresponding artificial intelligence model parameter sets.

9) The method of item 8), further comprising:
receiving a plurality of local training results from a plurality of UEs, wherein a local training result of each UE is obtained by the UE training a corresponding artificial intelligence model by using a local measurement result, and the local measurement result of each UE comprises at least reference signal measurement times and receiving beam selection results corresponding to the reference signal measurement times;
classifying the plurality of local training results from the plurality of UEs to obtain a plurality of sets of local training results based on at least one of:
   the beam intensity-based base station beam ranking sequences; or
   the beam intensity-based base station beam ranking sequences and the beam prediction periods;
merging each set of local training results in the plurality of sets of local training results to obtain a plurality of merging results; and
updating artificial intelligence model parameter sets in the data table using the plurality of merging results.

10) The method of item 8), further comprising:
receiving a plurality of local measurement results from a plurality of UEs, wherein the local measurement result of each UE comprises at least reference signal measurement times and receiving beam selection results corresponding to the reference signal measurement times;
classifying data of the plurality of local measurement results from the plurality of UEs to obtain at least one set of training data based on at least one of:
   the beam intensity-based base station beam ranking sequences, or
   the beam intensity-based base station beam ranking sequences and the beam prediction periods;
training a corresponding artificial intelligence model in the plurality of artificial intelligence models using the at least one set of training data to obtain at least one training result; and
updating the artificial intelligence model parameter set in the data table using the at least one training result.

11) The method of item 8), further comprising:
generating radio resource control (RRC) signaling containing information for indicating an alternative artificial intelligence model; and
sending the RRC signaling to the UE.

12) The method of item 10), wherein the RRC signaling contains a plurality of alternative artificial intelligence models, the method further comprising:
generating a MAC control element or downlink control information (DCI) for indicating one of the plurality of alternative artificial intelligence models; and
sending the MAC control element or DCI to the UE.

13) A network device, comprising:
a memory storing computer-executable instructions; and
a processor coupled with the memory and configured to execute the computer-executable instructions to perform operations of the method of any of items 1)-12).

14) A method performed by a user equipment (UE), comprising:
reporting, to a network device, a beam measurement result; and
receiving, from the network device, indication information associated with an artificial intelligence model for beam prediction for the UE, wherein the artificial intelligence model for beam prediction for the UE is determined by the network device from a plurality of artificial intelligence models for beam prediction based on the beam measurement result.

15) The method of item 14), further comprising: performing beam prediction between two pre-configured beam measurements by using the artificial intelligence model indicated by the indication information, and performing transmission by using a predicted beam.

16) The method of item 14), further comprising: performing beam prediction between two pre-configured beam measurements by using the artificial intelligence model indicated by the indication information, and preferentially measuring one or more predicted beams in a next beam measurement.

17) The method of item 14), further comprising: determining whether to perform beam prediction using the artificial intelligence model indicated by the indication information according to at least one of a moving velocity of the UE, a current communication link quality, or a transmission business requirement.

18) The method of item 14), wherein the beam measurement result comprises a beam intensity-based base station beam ranking sequence.

19) The method of item 14), further comprising:
sending, to the network device, information associated with a beam prediction period,
wherein the artificial intelligence model for beam prediction for the UE is determined by the network device based on both the beam measurement result and the information associated with the beam prediction period; and
the method further comprising:
performing beam prediction using the artificial intelligence model indicated by the indication information.

20) The method of item 14), wherein the indication information associated with the artificial intelligence model for beam prediction for the UE indicates a plurality of alternative artificial intelligence models, the method further comprising:
determining a beam prediction period;
selecting an artificial intelligence model corresponding to the determined beam prediction period from the plurality of alternative artificial intelligence models; and
performing beam prediction using the selected artificial intelligence model.

21) The method of item 14), wherein the indication information is transmitted via at least one of:
RRC signaling; or
high-layer signaling; or
DCI indication.

22) The method of item 14), further comprising:
sending, to the network device, a request for the artificial intelligence model for beam prediction.

23) The method of item 14), further comprising:
sending, to the network device, capability information, which indicates information of support of the UE for the artificial intelligence model for beam prediction.

24) The method of item 14), further comprising:
training the artificial intelligence model indicated by the indication information using a local measurement result to obtain a local training result, wherein the local measurement result comprises at least reference signal measurement times and receiving beam selection results corresponding to the reference signal measurement times; and
sending the local training result to the network device.

25) The method of item 14), further comprising:
sending, to the network device, a local measurement result, which comprises at least reference signal measurement times and receiving beam selection results corresponding to the reference signal measurement times.

26) The method of item 14), further comprising:
receiving RRC signaling containing information for indicating an alternative artificial intelligence model.

27) The method of item 26), wherein the RRC signaling contains a plurality of alternative artificial intelligence models, the method further comprising:
receiving a MAC control element or downlink control information (DCI) for indicating one of the plurality of alternative artificial intelligence models.

28) A user equipment, comprising:
a memory storing computer-executable instructions; and
a processor coupled with the memory and configured to execute the computer-executable instructions to perform operations of the method of any of items 14)-27).

### APPLICATION EXAMPLES OF THE PRESENT DISCLOSURE

The techniques described in this disclosure can be applied to a variety of products.

For example, an electronic device according to an embodiment of the present disclosure may be implemented as or installed in various base stations, or implemented as or installed in various user devices.

The communication methods according to the embodiments of the present disclosure may be implemented by various base stations or UEs; the methods and operations according to the embodiments of the present disclosure may be embodied as computer-executable instructions, which are stored in a non-transitory computer-readable storage medium, and may be executed by various base stations or UEs to implement one or more of the functions described above.

The techniques according to the embodiments of the present disclosure may be made into various computer program products, which are used in various base stations or UEs to implement one or more of the functions described above.

The base station described in this disclosure may be implemented as any type of base station, preferably such as a macro gNB and ng-eNB defined in the 5G NR standard of 3GPP. The gNB may be a gNB covering a cell smaller than a macro cell, such as a pico gNB, a micro gNB, and a homehold (femto) gNB. Alternatively, the base station may be implemented as any other type of base station, such as a NodeB, eNodeB, and base transceiver station (BTS). The base station may further include: one or more remote radio heads (RRHs) configured to control a body of radio communication and arranged in a different location from the body, a radio repeater, an unmanned aerial vehicle tower, control nodes in an automated plant, and the like.

The UE may be implemented as a mobile terminal (such as a smartphone, a tablet personal computer (PC), a notebook PC, a portable game terminal, a portable/dongle-type mobile router, and a digital camera), or a car-mounted terminal (such as a car navigation device). The UE may also be implemented as a terminal performing machine-to-machine (M2M) communication (also referred to as a machine type communication (MTC) terminal), an unmanned aerial vehicle, sensors and actuators in an automated plant, etc. Furthermore, the UE may be a radio communication module (such as an integrated circuit module including a single chip) mounted on each of the above terminals.

Examples of the base station and UE to which the technique of this disclosure can be applied are briefly described below.

It should be understood that the term “base station” used in this disclosure has a full breadth of its ordinary meaning and includes at least a radio communication station used as a portion of a wireless communication system or radio system to facilitate communication. Examples of the base station may be, for example, but is not limited to: one or both of a base transceiver station (BTS) and a base station controller (BSC) in a GSM communication system; one or both of a radio network controller (RNC) and a NodeB in a 3G communication system; an eNB in 4G LTE and LTE-A systems; and a gNB and ng-eNB in a 5G communication system. In D2D, M2M, and V2V communication scenarios, a logical entity having a control function for communication may also be referred to as the base station. In a cognitive radio communication scenario, a logical entity functioning as spectrum coordination may also be referred to as the base station. In an automated plant, a logical entity providing a network control function may be referred to as the base station.

### First Application Example of Base Station

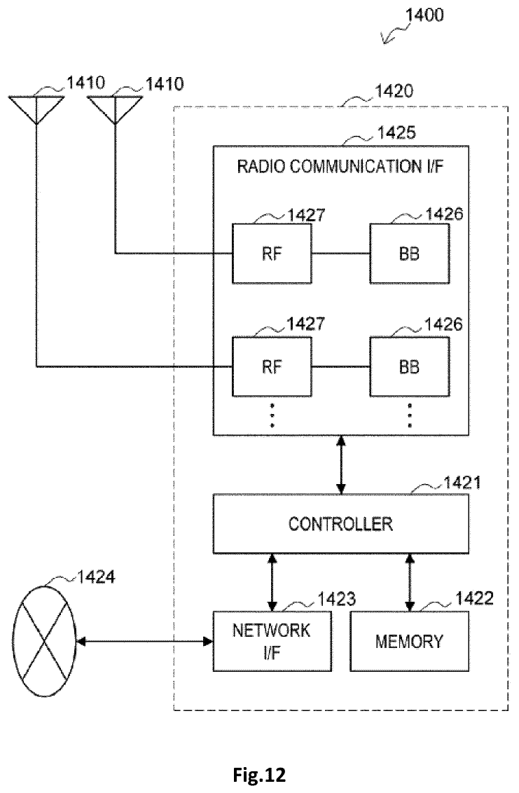

FIG. 12 is a block diagram illustrating a first example of a schematic configuration of a base station to which the technique of the present disclosure can be applied. In FIG. 12, the base station may be implemented as a gNB 1400. The gNB 1400 includes a plurality of antennas 1410 and a base station device 1420. The base station device 1420 and each antenna 1410 may be connected to each other via an RF cable.

The antenna 1410 includes a plurality of antenna elements, such as a plurality of antenna arrays for massive MIMO. The antenna 1410 may be arranged as, for example, an antenna array matrix, and used by the base station device 1420 for transmitting and receiving radio signals. For example, the plurality of antennas 1410 may be compatible with a plurality of frequency bands used by the gNB 1400.

The base station device 1420 includes a controller 1421, a memory 1422, a network interface 1423, and a radio communication interface 1425.

The controller 1421 may be, for example, a CPU or DSP, and operates various functions of higher layers of the base station device 1420. For example, the controller 1421 generates a data packet according to data in a signal processed by the radio communication interface 1425, and transmits the generated packet via the network interface 1423. The controller 1421 may bundle data from a plurality of baseband processors to generate a bundle packet, and transmit the generated bundle packet. The controller 1421 may have a logic function of performing the following control: such as radio resource control, radio bearer control, mobile management, admission control and scheduling. This control may be performed in conjunction with a nearby gNB or core network node. The memory 1422 includes a RAM and a ROM, and stores a program executed by the controller 1421 and various types of control data (such as a terminal list, transmission power data, and scheduling data).

The network interface 1423 is a communication interface for connecting the base station device 1420 to a core network 1424 (e.g., a 5G core network). The controller 1421 may communicate with a core network node or another gNB via the network interface 1423. In this case, the gNB 1400 and the core network node or other gNB may be connected to each other through a logical interface such as an NG interface and an Xn interface. The network interface 1423 may also be a wired communication interface, or a radio communication interface for a radio backhaul. If the network interface 1423 is a radio communication interface, the network interface 1423 may use a higher frequency band for radio communication, compared to a frequency band used by the radio communication interface 1425.

The radio communication interface 1425 supports any cellular communication solution (such as 5G NR), and provides a radio connection to a terminal located in a cell of the gNB 1400 via the antenna 1410. The radio communication interface 1425 may generally include, for example, a baseband (BB) processor 1426 and an RF circuit 1427. The BB processor 1426 may perform, for example, encoding/decoding, modulation/demodulation, and multiplexing/demultiplexing, and perform various types of signal processing for various layers (e.g., a physical layer, MAC layer, RLC layer, PDCP layer, SDAP layer). Instead of the controller 1421, the BB processor 1426 may have some or all of the above logic functions. The BB processor 1426 may be a memory for storing a communication control program, or a module including a processor configured to execute a program and related circuits. Updating the program may make the function of the BB processor 1426 change. The module may be a card or blade inserted into a slot of the base station device 1420. Alternatively, the module may be a chip mounted on a card or blade. Meanwhile, the RF circuit 1427 may include, for example, a mixer, a filter, and an amplifier, and transmit and receive a radio signal via the antenna 1410. Although FIG. 12 shows the example that one RF circuit 1427 is connected with one antenna 1410, the present disclosure is not limited to this illustration, and instead the one RF circuit 1427 may be connected with a plurality of antennas 1410 at the same time.

As shown in FIG. 12, the radio communication interface 1425 may include a plurality of BB processors 1426. For example, the plurality of BB processors 1426 may be compatible with the plurality of frequency bands used by the gNB 1400. As shown in FIG. 12, the radio communication interface 1425 may include a plurality of RF circuits 1427. For example, the plurality of RF circuits 1427 may be compatible with the plurality of antenna elements. Although FIG. 12 shows the example that the radio communication interface 1425 includes the plurality of BB processors 1426 and the plurality of RF circuits 1427, the radio communication interface 1425 may further include a single BB processor 1426 or a single RF circuit 1427.

In the gNB 1400 shown in FIG. 12, one or more units (e.g., the sending unit 1003, the receiving unit 2002, the receiving unit 3003, or the like) included in the processing circuit 1001, 2001, 3001, or 4001 may be implemented in the radio communication interface 1425. Alternatively, at least a portion of these components may be implemented in the controller 1421. For example, the gNB 1400 includes a portion (e.g., the BB processor 1426) or the entirety of the radio communication interface 1425 and/or a module including the controller 1421, and one or more components can be implemented in the module. In this case, the module may store a program for allowing the processor to function as one or more components (in other words, a program for allowing the processor to perform operations of the one or more components), and may execute the program. As another example, a program for allowing the processor to function as one or more components can be installed in the gNB 1400, and the radio communication interface 1425 (e.g., the BB processor 1426) and/or controller 1421 can execute the program. As described above, as a device including one or more components, the gNB 1400, the base station device 1420, or the module may be provided, and the program for allowing the processor to function as one or more components may be provided. In addition, a readable medium in which the program is recorded may be provided.

### Second Application Example of Base Station

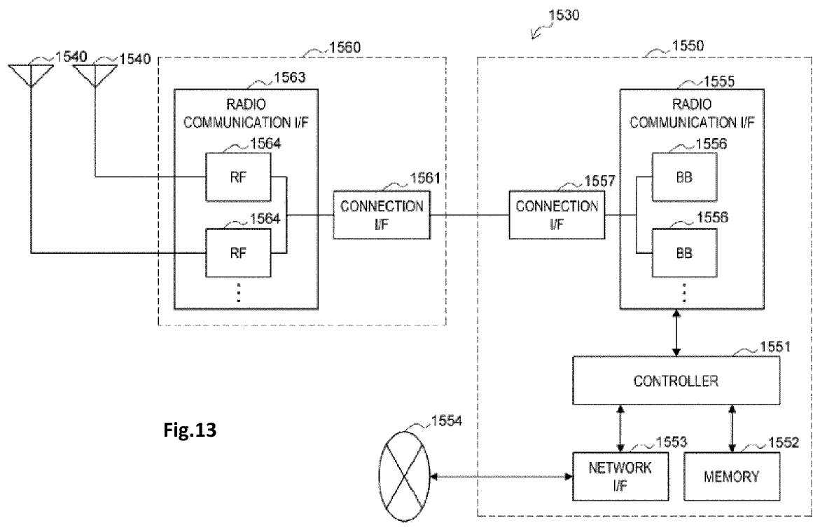

FIG. 13 is a block diagram illustrating a second example of a schematic configuration of a base station to which the technique of the present disclosure can be applied. In FIG. 13, the base station is shown as a gNB 1530. The gNB 1530 includes a plurality of antennas 1540, a base station device 1550, and an RRH 1560. The RRH 1560 and each antenna 1540 may be connected to each other via an RF cable. The base station device 1550 and the RRH 1560 may be connected to each other via a high-speed line such as an optical fiber cable.

The antenna 1540 includes a plurality of antenna elements, such as a plurality of antenna arrays for massive MIMO. The antenna 1540 may be arranged as, for example, an antenna array matrix, and used for transmitting and receiving radio signals by the base station device 1550. For example, the plurality of antennas 1540 may be compatible with a plurality of frequency bands used by the gNB 1530.

The base station device 1550 includes a controller 1551, a memory 1552, a network interface 1553, a radio communication interface 1555, and a connection interface 1557. The controller 1551, memory 1552, and network interface 1553 are the same as the controller 1421, memory 1422 and network interface 1423 described with reference to FIG. 13.

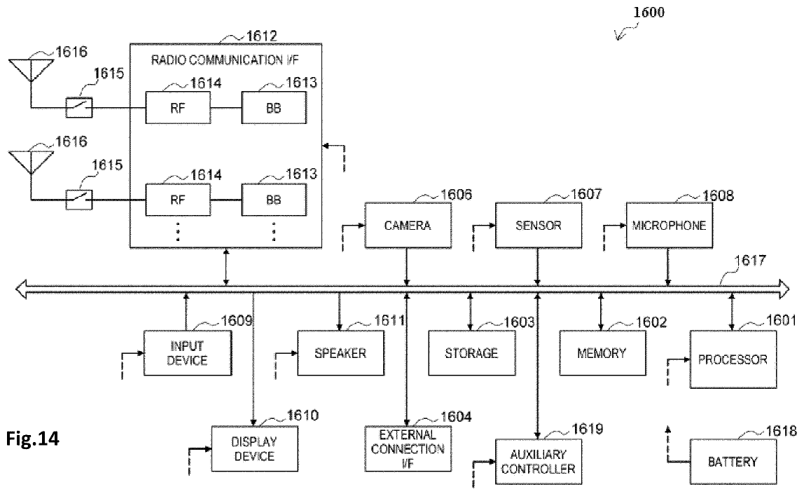

The radio communication interface 1555 supports any cellular communication solution (such as 5G NR), and provides radio communication to a terminal located in a sector corresponding to the RRH 1560 via the RRH 1560 and the antenna 1540. The radio communication interface 1555 may generally include, for example, a BB processor 1556. The BB processor 1556 is the same as the BB processor 1426 described with reference to FIG. 14, except that the BB processor 1556 is connected to an RF circuit 1564 of the RRH 1560 via the connection interface 1557. As shown in FIG. 13, the radio communication interface 1555 may include a plurality of BB processors 1556. For example, the plurality of BB processors 1556 may be compatible with the plurality of frequency bands used by the gNB 1530. Although FIG. 13 shows the example that the radio communication interface 1555 includes the plurality of BB processors 1556, the radio communication interface 1555 can also include a single BB processor 1556.

The connection interface 1557 is an interface for connecting the base station device 1550 (radio communication interface 1555) to the RRH 1560. The connection interface 1557 may also be a communication module for communication in the above high-speed line connecting the base station device 1550 (radio communication interface 1555) to the RRH 1560.

The RRH 1560 includes a connection interface 1561 and a radio communication interface 1563.

The connection interface 1561 is an interface for connecting the RRH 1560 (radio communication interface 1563) to the base station device 1550. The connection interface 1561 may also be a communication module for communication in the above high-speed line.

The radio communication interface 1563 transmits and receives radio signals via the antenna 1540. The radio communication interface 1563 may generally include, for example, the RF circuit 1564. The RF circuit 1564 may include, for example, a mixer, a filter, and an amplifier, and transmits and receives radio signals via the antenna 1540. Although FIG. 13 shows the example that one RF circuit 1564 is connected with one antenna 1540, the present disclosure is not limited to this illustration, and instead the one RF circuit 1564 may be connected with a plurality of antennas 1540 at the same time.

As shown in FIG. 13, the radio communication interface 1563 may include a plurality of RF circuits 1564. For example, the plurality of RF circuits 1564 may support the plurality of antenna elements. Although FIG. 13 shows the example that the radio communication interface 1563 includes the plurality of RF circuits 1564, the radio communication interface 1563 may also include a single RF circuit 1564.

In the gNB 1500 shown in FIG. 13, one or more units (e.g., the sending unit 1003, the receiving unit 2002, the receiving unit 3003, or the like) included in the processing circuit 1001, 2001, 3001, or 4001 may be implemented in the radio communication interface 1525. Alternatively, at least a portion of these components may be implemented in the controller 1521. For example, the gNB 1500 includes a portion (e.g., the BB processor 1526) or the entirety of the radio communication interface 1525 and/or a module including the controller 1521, and one or more components can be implemented in the module. In this case, the module may store a program for allowing the processor to function as one or more components (in other words, a program for allowing the processor to perform operations of the one or more components), and may execute the program. As another example, a program for allowing the processor to function as one or more components can be installed in the gNB 1500, and the radio communication interface 1525 (e.g., the BB processor 1526) and/or the controller 1521 can perform the program. As described above, as a device including one or more components, the gNB 1500, the base station device 1520, or the module may be provided, and the program for allowing the processor to function as one or more components may be provided. In addition, a readable medium in which the program is recorded may be provided.

### First Application Example of UE

FIG. 14 is a block diagram illustrating an example of a schematic configuration of a smartphone 1600 to which the technique of the present disclosure can be applied.

The smartphone 1600 includes a processor 1601, a memory 1602, a storage device 1603, an external connection interface 1604, a camera device 1606, a sensor 1607, a microphone 1608, an input device 1609, a display device 1610, a speaker 1611, a radio communication interface 1612, one or more antenna switches 1615, one or more antennas 1616, a bus 1617, a battery 1618, and an auxiliary controller 1619.

The processor 1601 may be, for example, a CPU or a system on a chip (SoC), and controls functions of an application layer and other layers of the smartphone 1600. The processor 1601 may include or serve as any of the processing circuit 1001, 2001, 3001, 4001 described with reference to the accompanying drawings. The memory 1602 includes a RAM and a ROM, and stores data and a program executed by the processor 1601. The storage device 1603 may include a storage medium such as a semiconductor memory and a hard disk. The external connection interface 1604 is an interface for connecting an external device (such as a memory card and a universal serial bus (USB) device) to the smartphone 1600.

The camera device 1606 includes an image sensor (such as a charge coupled device (CCD) and a complementary metal oxide semiconductor (CMOS)), and generates a capture image. The sensor 1607 may include a set of sensors such as measurement sensors, gyro sensors, geomagnetic sensors, and acceleration sensors. The microphone 1608 converts sound input to the smartphone 1600 into an audio signal. The input device 1609 includes, for example, a touch sensor configured to detect a touch on a screen of the display device 1610, a keypad, a keyboard, a button, or a switch, and receives an operation or information input from a user. The display device 1610 includes a screen (such as a liquid crystal display (LCD) and an organic light emitting diode (OLED) display), and displays an output image of the smartphone 1600. The speaker 1611 converts an audio signal output from the smartphone 1600 into sound.

The radio communication interface 1612 supports any cellular communication solution (such as 4G LTE or 5G NR) and performs radio communication. The radio communication interface 1612 may generally include, for example, a BB processor 1613 and an RF circuit 1614. The BB processor 1613 may perform, for example, encoding/decoding, modulation/demodulation, and multiplexing/demultiplexing, and perform various types of signal processing for radio communication. Meanwhile, the RF circuit 1614 may include, for example, a mixer, a filter, and an amplifier, and transmit and receive radio signals via the antenna 1616. The radio communication interface 1612 may be one chip module having the BB processor 1613 and the RF circuit 1614 integrated thereon. As shown in FIG. 14, the radio communication interface 1612 may include a plurality of BB processors 1613 and a plurality of RF circuits 1614. Although FIG. 14 shows the example that the radio communication interface 1612 includes the plurality of BB processors 1613 and the plurality of RF circuits 1614, the radio communication interface 1612 may also include a single BB processor 1613 or a single RF circuit 1614.

Furthermore, in addition to the cellular communication solution, the radio communication interface 1612 may support another type of radio communication solution, such as a short-range radio communication solution, a near field communication solution, and a wireless local area network (LAN) solution. In this case, the radio communication interface 1612 may include the BB processor 1613 and the RF circuit 1614 for each radio communication solution.

Each of the antenna switches 1615 switches a connection destination of the antenna 1616 between a plurality of circuits (for example, circuits for different radio communication solutions) included in the radio communication interface 1612.

The antenna 1616 includes a plurality of antenna elements, such as a plurality of antenna arrays for massive MIMO. The antenna 1616 may be arranged as, for example, an antenna array matrix, and used by the radio communication interface 1612 for transmitting and receiving radio signals. The smartphone 1600 may include one or more antenna panels (not shown).

Furthermore, the smartphone 1600 may include the antenna 1616 for each radio communication solution. In this case, the antenna switch 1615 may be omitted from the configuration of the smartphone 1600.

The bus 1617 connects the processor 1601, the memory 1602, the storage device 1603, the external connection interface 1604, the camera device 1606, the sensor 1607, the microphone 1608, the input device 1609, the display device 1610, the speaker 1611, the radio communication interface 1612, and the auxiliary controller 1619 to each other. The battery 1618 provides power to the various blocks of the smartphone 1600 shown in FIG. 14 via a feeder, which is partially shown as a dashed line in the figure. The auxiliary controller 1619 operates minimum necessary functions of the smartphone 1600, for example, in a sleep mode.

In the smartphone 1600 shown in FIG. 14, one or more units (e.g., the sending unit 1003, the receiving unit 2002, the receiving unit 3003, etc.) included in the processing circuit 1001, 2001, 3001, or 4001 may be implemented in the radio communication interface 1612. Alternatively, at least a portion of these components may be implemented in the processor 1601 or the auxiliary controller 1619. As one example, the smartphone 1600 includes a portion (e.g., the BB processor 1613) or the entirety of the radio communication interface 1612, and/or a module including the processor 1601 and/or the auxiliary controller 1619, and one or more components may be implemented in the module. In this case, the module may store a program allowing the processer to function as one or more components (in other words, a program for allowing the processor to perform operations of the one or more components), and may perform the program. As another example, a program for allowing the processor to function as one or more components may be installed in the smartphone 1600, and the radio communication interface 1612 (e.g., the BB processor 1613), the processor 1601, and/or the auxiliary controller 1619 may perform the program. As described above, as a device including one or more components, the smartphone 1600 or the module may be provided, and the program for allowing the processor to function as one or more components may be provided. In addition, a readable medium in which the program is recorded may be provided.

### Second Application Example of UE

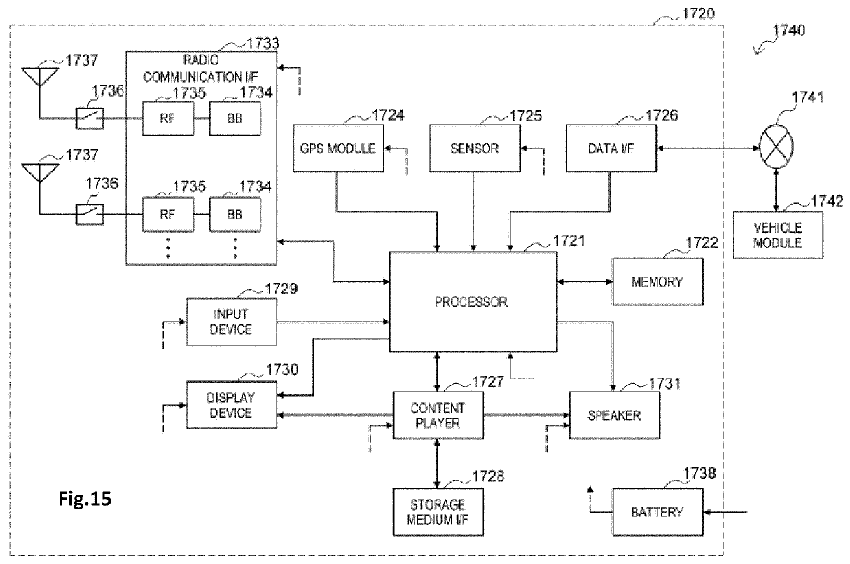

FIG. 15 is a block diagram illustrating an example of a schematic configuration of a car navigation device 1720 to which the technique of the present disclosure can be applied. The car navigation device 1720 includes a processor 1721, a memory 1722, a global positioning system (GPS) module 1724, a sensor 1725, a data interface 1726, a content player 1727, a storage medium interface 1728, an input device 1729, a display device 1730, a speaker 1731, a radio communication interface 1733, one or more antenna switches 1736, one or more antennas 1737, and a battery 1738.

The processor 1721 may be, for example, a CPU or SoC, and control a navigation function and other functions of the car navigation device 1720. The memory 1722 includes a RAM and a ROM, and stores data and a program executed by the processor 1721.

The GPS module 1724 measures a location (such as latitude, longitude, and altitude) of the car navigation device 1720 using a GPS signal received from a GPS satellite. The sensor 1725 may include a set of sensors such as gyroscope sensors, geomagnetic sensors, and air pressure sensors. The data interface 1726 is connected to, for example, a car-mounted network 1741 via a terminal not shown, and acquires data generated by a vehicle (such as vehicle velocity data).

The content player 1727 reproduces content stored in a storage medium (such as a CD and a DVD), which is inserted into the storage medium interface 1728. The input device 1729 includes, for example, a touch sensor configured to detect a touch on a screen of the display device 1730, a button, or a switch, and receives an operation or information input from a user. The display device 1730 includes a screen such as an LCD or OLED display, and displays an image of a navigation function or reproduced content. The speaker 1731 outputs sound of the navigation function or reproduced content.

The radio communication interface 1733 supports any cellular communication solution (such as 4G LTE or 5G NR) and performs radio communication. The radio communication interface 1733 may generally include, for example, a BB processor 1734 and an RF circuit 1735. The BB processor 1734 may perform, for example, encoding/decoding, modulation/demodulation, and multiplexing/demultiplexing, and perform various types of signal processing for radio communication. Meanwhile, the RF circuit 1735 may include, for example, a mixer, a filter, and an amplifier, and transmit and receive radio signals via the antenna 1737. The radio communication interface 1733 may also be a chip module having the BB processor 1734 and the RF circuit 1735 integrated thereon. As shown in FIG. 15, the radio communication interface 1733 may include a plurality of BB processors 1734 and a plurality of RF circuits 1735. Although FIG. 15 shows the example that the radio communication interface 1733 includes the plurality of BB processors 1734 and the plurality of RF circuits 1735, the radio communication interface 1733 may also include a single BB processor 1734 or a single RF circuit 1735.

Furthermore, in addition to the cellular communication solution, the radio communication interface 1733 may support additional types of radio communication solutions, such as a short-range radio communication solution, a near field communication solution, and a wireless LAN solution. In this case, for each radio communication solution, the radio communication interface 1733 may include the BB processor 1734 and the RF circuit 1735.

Each of the antenna switches 1736 switches a connection destination of the antenna 1737 between a plurality of circuits (such as circuits for different radio communication solutions) included in the radio communication interface 1733.

The antenna 1737 includes a plurality of antenna elements, such as a plurality of antenna arrays for massive MIMO. The antenna 1737 may be arranged as, for example, an antenna array matrix, and used by the radio communication interface 1733 for transmitting and receiving radio signals.

Furthermore, the car navigation device 1720 may include an antenna 1737 for each radio communication solution. In this case, the antenna switch 1736 may be omitted from the configuration of the car navigation device 1720.

The battery 1738 provides power to the various blocks of the car navigation device 1720 shown in FIG. 15 via a feeder, which is partially shown as a dashed line in the figure. The battery 1738 accumulates power supplied from the vehicle.

In the car navigation device 1720 shown in FIG. 15, one or more units (e.g., the sending unit 1003, the receiving unit 2002, the receiving unit 3003, or the like) included in the processing circuit 1001, 2001, 3001, or 4001 may be implemented in the radio communication interface 1733. Alternatively, at least a portion of these components may be implemented in the processor 1721. As one example, the car navigation device 1720 includes a portion (e.g., the BB processor 1734) or the entirety of the radio communication interface 1733 and/or a module including the processor 1721, and one or more components may be implemented in the module. In this case, the module may store a program allowing the processor to function as one or more components (in other words, a program for allowing the processor to perform operations of the one or more components), and may execute the program. As another example, a program for allowing the processor to function as one or more components may be installed in the car navigation device 1720, and the radio communication interface 1733 (e.g., the BB processor 1734) and/or the processor 1721 may execute the program. As described above, as a device including one or more components, the car navigation device 1720 or the module may be provided, and the program for allowing the processor to function as one or more components may be provided. In addition, a readable medium in which the program is recorded may be provided.

The technique of this disclosure may also be implemented as a car-mounted system (or vehicle) 1740 including the car navigation device 1720, a car-mounted network 1741, and one or more blocks of a vehicle module 1742. The vehicle module 1742 generates vehicle data (such as vehicle velocity, engine velocity, and fault information) and outputs the generated data to the car-mounted network 1741.

The exemplary embodiments of the present disclosure are described above with reference to the drawings, but the present disclosure is of course not limited to the above examples. Various changes and modifications may be obtained by those skilled in the art within the scope of the attached claims, and it should be understood that these changes and modifications naturally fall within the technical scope of the present disclosure.

For example, a plurality of functions included in one unit in the above embodiments may be implemented by separate devices. Alternatively, a plurality of functions implemented by a plurality of units in the above embodiments may be implemented by separate devices, respectively. In addition, one of the above functions may be implemented by a plurality of units. Needless to say, such a configuration is included in the technical scope of the present disclosure.

In this specification, the steps described in the flow diagrams include not only the processing performed in temporal sequence in the described order, but also the processing performed in parallel or individually rather than necessarily in the temporal sequence. Furthermore, even in the steps processed in temporal sequence, needless to say, the order can be appropriately changed.

Although the present disclosure and its advantages have been described in detail, it should be understood that various changes, substitutions and alterations can be made without departing from the spirit and scope of the present disclosure that are defined by the attached claims. Furthermore, the terms “comprise”, “include”, or any other variation thereof, in the embodiments of the present disclosure are intended to cover a non-exclusive inclusion, such that a process, method, article, or device that comprises a list of elements not only includes those elements, but also includes other elements not expressly listed, or also includes elements inherent to such process, method, article, or device. Without further limitations, an element defined by the phrase “comprising an . . . ” does not exclude the presence of other identical elements in the process, method, article, or device that includes the element.

1. A method performed by a network device, comprising:
determining an artificial intelligence model for a user equipment (UE) from a plurality of artificial intelligence models for beam prediction based on a beam measurement result reported by the UE; and
sending, to the UE, indication information associated with the determined artificial intelligence model.

2. The method of claim 1, wherein the beam measurement result reported by the UE comprises a beam intensity-based base station beam ranking sequence.

3. The method of claim 1, further comprising:
receiving, from the UE, information associated with a beam prediction period of the UE; and
determining the artificial intelligence model for beam prediction for the UE based on both the beam measurement result and the information associated with the beam prediction period of the UE.

4. The method of claim 1, further comprising:
determining a spatial location of the UE, and
determining the artificial intelligence model for beam prediction for the UE based on the spatial location of the UE.

5. The method of claim 1, further comprising sending, to the UE, the indication information associated with the determined artificial intelligence model via at least one of:
RRC signaling; or
high-layer signaling; or
DCI indication.

6. The method of claim 1, further comprising:
receiving, from the UE, a request for the artificial intelligence model for beam prediction.

7. The method of claim 1, further comprising:
receiving, from the UE, capability information, which indicates information of support of the UE for the artificial intelligence model for beam prediction.

8. The method of claim 1, wherein each artificial intelligence model is defined by one model parameter set, the method further comprising:
maintaining a data table, wherein the data table comprises at least:
beam intensity-based base station beam ranking sequences and corresponding artificial intelligence model parameter sets; or the beam intensity-based base station beam ranking sequences, beam prediction periods, and corresponding artificial intelligence model parameter sets.

9. The method of claim 8, further comprising:
receiving a plurality of local training results from a plurality of UEs, wherein the local training result of each UE is obtained by the UE training a corresponding artificial intelligence model by using a local measurement result, and the local measurement result of each UE comprises at least reference signal measurement times and receiving beam selection results corresponding to the reference signal measurement times;
classifying the plurality of local training results from the plurality of UEs to obtain a plurality of sets of local training results based on at least one of:
the beam intensity-based base station beam ranking sequences; or
the beam intensity-based base station beam ranking sequences and the beam prediction periods;
merging each set of local training results in the plurality of sets of local training results to obtain a plurality of merging results; and
updating the artificial intelligence model parameter sets in the data table using the plurality of merging results.

10. The method of claim 8, further comprising:
receiving a plurality of local measurement results from a plurality of UEs, wherein the local measurement result of each UE comprises at least reference signal measurement times and receiving beam selection results corresponding to the reference signal measurement times;
classifying data of the plurality of local measurement results from the plurality of UEs to obtain at least one set of training data based on at least one of:
the beam intensity-based base station beam ranking sequences, or
the beam intensity-based base station beam ranking sequences and the beam prediction periods;
training a corresponding artificial intelligence model in the plurality of artificial intelligence models using the at least one set of training data to obtain at least one training result; and
updating the artificial intelligence model parameter set in the data table using the at least one training result.

11. The method of claim 8, further comprising:
generating radio resource control (RRC) signaling containing information for indicating an alternative artificial intelligence model; and
sending the RRC signaling to the UE.

12. The method of claim 10, wherein the RRC signaling contains a plurality of alternative artificial intelligence models, the method further comprising:
generating a MAC control element or downlink control information (DCI) for indicating one of the plurality of alternative artificial intelligence models; and
sending the MAC control element or DCI to the UE.

13. A network device, comprising:
a memory storing computer-executable instructions; and
a processor coupled with the memory and configured to execute the computer-executable instructions to perform operations of the method of claim 1.

14. A method performed by a user equipment (UE), comprising:
reporting, to a network device, a beam measurement result; and
receiving, from the network device, indication information associated with an artificial intelligence model for beam prediction for the UE, wherein the artificial intelligence model for beam prediction for the UE is determined by the network device from a plurality of artificial intelligence models for beam prediction based on the beam measurement result.

15. The method of claim 14, further comprising: performing beam prediction between two pre-configured beam measurements by using the artificial intelligence model indicated by the indication information, and performing transmission by using a predicted beam.

16. The method of claim 14, further comprising: performing beam prediction between two pre-configured beam measurements by using the artificial intelligence model indicated by the indication information, and preferentially measuring one or more predicted beams in a next beam measurement.

17. The method of claim 14, further comprising: determining whether to perform beam prediction using the artificial intelligence model indicated by the indication information according to at least one of a moving velocity of the UE, a current communication link quality, or a transmission business requirement.

18. The method of claim 14, wherein the beam measurement result comprises a beam intensity-based base station beam ranking sequence.

19. The method of claim 14, further comprising:
sending, to the network device, information associated with a beam prediction period,
wherein the artificial intelligence model for beam prediction for the UE is determined by the network device based on both the beam measurement result and the information associated with the beam prediction period; and
the method further comprising:
performing beam prediction using the artificial intelligence model indicated by the indication information.

20.-27. (canceled)

28. A user equipment, comprising:
a memory storing computer-executable instructions; and
a processor coupled with the memory and configured to execute the computer-executable instructions to perform the operations of the method of claim 1.
